(19) United States
(12) Patent Application Publication
(10) Pub. No.: US 2016/0355011 A1
(43) Pub. Date: Dec. 8, 2016

(54) INKJET RECORDING METHOD AND INKJET RECORDING DEVICE

(71) Applicants: Kiminori MASUDA, Tokyo (JP); Naoko Kitaoka, Kanagawa (JP); Satomi Araki, Kanagawa (JP)

(72) Inventors: Kiminori MASUDA, Tokyo (JP); Naoko Kitaoka, Kanagawa (JP); Satomi Araki, Kanagawa (JP)

(21) Appl. No.: 15/164,200

(22) Filed: May 25, 2016

(30) Foreign Application Priority Data
Jun. 4, 2015 (JP) 2015-114169
Aug. 28, 2015 (JP) 2015-169249
Apr. 1, 2016 (JP) 2016-074452

(51) Int. Cl. B41J 2/045

(52) U.S. Cl. CPC B41J 2/04588; B41J 2/04581

(57) ABSTRACT

An inkjet recording method includes supplying ink to a recording head and applying at least one drive pulse to a pressure generating device in the recording head to generate a pressure in a liquid chamber in the recording head to discharge one or more droplets of the ink in the liquid chamber through a nozzle of a nozzle plate in the recording head, wherein the following two conditions are satisfied.

The ink has a static surface tension of from 18.0 to 27.0 mN/m at 25 degrees C.
Condition 1

The at least one drive pulse has a voltage changing portion for drawing in the ink, the voltage changing portion having a voltage changing time of one third or more of a resonance period of the liquid chamber
Condition 2.

### CROSS-REFERENCE TO RELATED APPLICATIONS

This patent application is based on and claims priority pursuant to 35 U.S.C. §119(a) to Japanese Patent Application Nos. 2015-114169, 2015-169249, and 2016-074452, filed on Jun. 4, 2015, Aug. 28, 2015, and Apr. 1, 2016, respectively, in the Japan Patent Office, the entire disclosures of which are hereby incorporated by reference herein.

### BACKGROUND

Technical Field

The present invention relates to an inkjet recording method and an inkjet recording device.

Description of the Related Art

Inkjet methods include discharging ink droplets from extremely fine nozzles and attaching the ink droplets to a recording medium to record images thereon. This method is advantageous and widely used since the process is simple, full colorization is easy, and high resolution images can be obtained with a simple structure in comparison with other recording methods.

Ink for use in such an inkjet recording method is demanded to have various characteristics. In particular, discharging stability of ink discharged from a head greatly affects the image quality.

In the inkjet recording method described above, pressures applied to the ink are fluctuated to discharge ink droplets.

A meniscus is formed inside the nozzle of the head filled with ink. Normally (stationary condition), the meniscus forms a bridge on the side of a liquid chamber with a nozzle edge as a reference point. However, when a positive pressure is applied to the ink in the nozzle as the pressure changes during discharging, the meniscus collapses and the ink may overflow outside the discharging hole of the ink. In addition, the tail of discharged ink droplet is broken off or fine ink mist developed as a result of scattering of ink caused by impact on a print target adheres to the surface of the nozzle plate. The ink overflowing from the discharging hole and the ink mist attached to the surface of the nozzle plate form an ink pool on the surface of the nozzle plate. If this pool contacts an ink droplet being discharging, which makes the meniscus uneven or pulls the ink droplet. For this reason, the discharging direction thereof may be deviated. Furthermore, in a case of ink using a pigment as a colorant, a solid portion of the pigment is dispersed in a solvent. When the ink attached to the surface of the nozzle plate dries, the solid portion adheres thereto, causing the nozzle to clog in the end.

As describe above, in the inkjet method, keeping the site around the nozzle clean is demanded to secure stable dischargibility. Therefore, to prevent contamination of the surface of the nozzle plate by ink, a repellent film is formed on the surface of the nozzle plate to easily repel the ink or the surface of the nozzle plate is wiped regularly to remove the ink thereon in general.

However, such a repellent film is known to be peeled off from the surface of the nozzle plate little by little due to wiping, etc.

Ink tends to adhere to the site where the repellent film is peeled off, which makes discharging unstable. As a consequence, ink displacement and streaks occur to printed matter, so that the image quality thereof deteriorates. In addition, depending on the property of ink, the ink sticks to the surface of the nozzle plate, which makes is difficult to easily remove the ink by wiping. In particular, when ink having a low static surface tension is discharged from a head, ink displacement and streaks occur to printed matter at the site where the repellent film is peeled off, thereby degrading the image quality.

### SUMMARY

According to the present disclosure, provided is an improved inkjet recording method of the present disclosure includes supplying ink to a recording head and applying a single or multiple drive pulses to a pressure generating device in the recording head to generate a pressure in a liquid chamber in the recording head to discharge a single or multiple droplets of the ink in the liquid chamber through a nozzle of a nozzle plate in the recording head. Also, the inkjet recording method satisfies the following two conditions.

The ink has a static surface tension of from 18.0 to 27.0 mN/m at 25 degrees C.
Condition 1

The at least one drive pulse has a voltage changing portion for drawing in the ink, the voltage changing portion having a voltage changing time of one third or more of a resonance period of the liquid chamber.
Condition 2.

### BRIEF DESCRIPTION OF THE SEVERAL VIEWS OF THE DRAWINGS

Various other objects, features and attendant advantages of the present invention will be more fully appreciated as the same become better understood from the detailed description when considered in connection with the accompanying drawings, in which like reference characters designate like corresponding parts throughout and wherein

FIG. 1 is a scanning electron microscope (SEM) image illustrating a state where the repellent film on the surface of a nozzle plate has deteriorated;

FIG. 2 is a schematic diagram illustrating a state of normal meniscus;

FIG. 3 is a schematic diagram illustrating meniscus overflowing occurring immediately after a liquid droplet is discharged;

FIG. 4 is a schematic diagram illustrating a state in which deviation of liquid droplet occurs;

FIG. 5A is a schematic diagram illustrating a state of typical meniscus overflowing;

FIG. 5B is a graph illustrating a drive pulse in the state illustrated in FIG. 5A;

FIG. 6A is a schematic diagram illustrating a state where overflown ink remains on a degraded repellent film during typical discharging;

FIG. 6B is a graph illustrating a drive pulse in the state illustrated in FIG. 6A;

FIG. 7A is a schematic diagram illustrating a state where deviation of liquid droplet occurs during typical discharging;

FIG. 7B is a graph illustrating a drive pulse in the state illustrated in FIG. 7A;

FIG. 8A is a schematic diagram illustrating a state of typical meniscus overflowing;

FIG. 8B is a graph illustrating a drive pulse in the state illustrated in FIG. 8A;

FIG. 9A is a schematic diagram illustrating a state where an ink 202 in a nozzle and the ink 202 on a degraded repellent film 200 are drawn in the nozzle;

FIG. 9B is a graph illustrating a drive pulse in the state illustrated in FIG. 9A;

FIG. 10A is a schematic diagram illustrating a state of drawing in the meniscus in the nozzle;

FIG. 10B is a graph illustrating a drive pulse in the state illustrated in FIG. 10A;

FIG. 11A is a schematic diagram illustrating a state where the ink 202 is being discharged;

FIG. 11B is a graph illustrating a drive pulse in the state illustrated in FIG. 11A;

FIG. 12 is a side view illustrating the entire configuration of an example of the inkjet recording device according to an embodiment of the present invention;

FIG. 13 is a plane view illustrating the entire configuration of an example of the inkjet recording device according to an embodiment of the present invention;

FIG. 14 is a cross section illustrating an example of the liquid discharging head constituting the recording head of the inkjet recording device in the longitudinal direction of the liquid chamber according to an embodiment of the present disclosure;

FIG. 15 is a cross section illustrating an example of the liquid discharging head constituting the recording head of the inkjet recording device in the traverse direction of the liquid chamber according to an embodiment of the present disclosure;

FIG. 16 is a block chart illustrating an example of the control unit of the inkjet recording device according to an embodiment of the present disclosure;

FIG. 17 is a diagram illustrating an example of the print control unit and the head driver of the inkjet recording device according to an embodiment of the present disclosure;

FIG. 18 is a graph illustrating a discharging waveform having a drive signal to draw in a meniscus in two steps;

FIG. 19 is a graph illustrating a discharging waveform having a drive signal to draw in a meniscus in a single step;

FIG. 20 is a diagram illustrating a single print cycle;

FIG. 21 is a diagram illustrating an example of the ink container according to an embodiment of the present invention; and

FIG. 22 is a diagram illustrating the ink container illustrated in FIG. 21 including its housing.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

Inkjet Recording Method and Inkjet Recording Device

The inkjet recording method of the present disclosure includes supplying ink to a recording head and applying a single or multiple drive pule to a pressure generating device. The pressure generating device is included in a recording head. The recording head includes a nozzle plate having a nozzle to discharge ink droplets and a liquid chamber communicating with the nozzle. The pressure generating device generates a pressure in the liquid chamber to discharge the ink droplet. Also, the inkjet recording method satisfies the following two conditions.

The ink has a static surface tension of from 18.0 to 27.0 mN/m at 25 degrees C.
Condition 1

The at least one drive pulse has a voltage changing portion drawing in the ink having a voltage changing time of one third or more of a resonance period of the liquid chamber
Condition 2.

The inkjet recording device of the present disclosure includes a recording head including a nozzle plate having a nozzle to discharge droplets of ink, a liquid chamber communicating with the nozzle, and a pressure generating device to generate a pressure in the liquid chamber, and a drive waveform generating unit to generate a waveform including at least one drive pulse applied to the pressure generating device.

The droplets of ink are discharged by the pressure generated by the pressure generating device.

Also, the following two conditions are satisfied:

The ink has a static surface tension of from 18.0 to 27.0 mN/m at 25 degrees C.
Condition 1

The at least one drive pulse has a voltage changing portion drawing in the ink having a voltage changing time of one third or more of a resonance period of the liquid chamber
Condition 2.

A flow path plate, a vibration plate, and a nozzle plate are laminated to form the recording head (hereinafter also referred to as a liquid discharging head or head). The vibration plate is attached to the bottom surface of the flow path plate and the nozzle plate is attached to the upper face of the flow path plate. These form the nozzle (nozzle hole) having a hole through which liquid droplets (ink droplets) are discharged. The nozzle discharging the ink droplet communicates with a nozzle communicating path, a liquid chamber serving as a pressure generating chamber, and an ink supply hole communicating with a common liquid chamber to supply the ink to the liquid chamber through a fluid resistance unit (supplying path), etc.

That is, the liquid discharging head includes the nozzle plate, the liquid chamber communicated with the nozzle hole discharging the ink droplet, and the pressure generating device to change the pressure to the liquid chamber.

The nozzle (nozzle hole) is formed on the nozzle plate for each liquid chamber. It is preferable that this nozzle plate be formed of, for example, a nozzle forming member such as a metal member and include a repellent layer (film) on the surface of the nozzle forming member on the side of ink discharging. That is, the surface of the nozzle (nozzle hole) on the side of ink discharging is preferably subject to repellency treatment.

In the inkjet recording method of the present disclosure, a print control unit, which is described later, generates a discharging pulse in response to the size of ink droplets. A drive pulse is selected from a drive waveform including one or more drive pulses in temporal sequence to form the discharging pulse.

“Drive pulse” means a pulse as an element constituting a drive waveform and “discharging pulse” means a pulse applied to a liquid discharging head including a pressure generating device to discharge ink droplets.

The drive pulse is formed of a waveform element (inflation waveform element) to inflate a liquid chamber by rising-down from a reference voltage to a predetermined hold voltage, a waveform element (holding element) to hold the risen-down voltage (hold voltage), and a waveform element (contraction waveform element) to contract the liquid chamber by rising up from the hold voltage.

In response to the size of ink droplets, a drive pulse is selected from a drive waveform including one or more drive pulses in temporal sequence to generate a discharging pulse. For example, a drive waveform discharging droplets of three sizes of large droplets, middle-sized droplets, and small droplets can be selected.

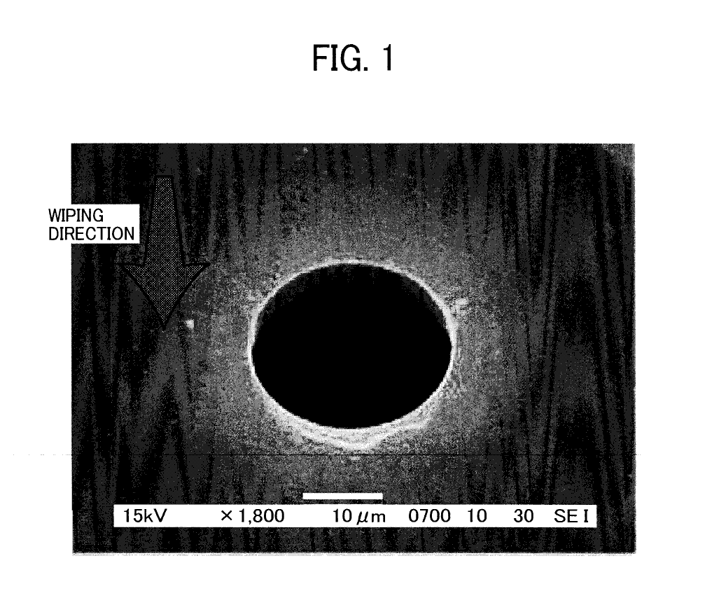

FIG. 1 illustrates a scanning electron microscope (SEM) image of a nozzle. As illustrated in FIG. 1, due to physical burden due to maintenance, the nozzle repellent film of the surface of the nozzle plate on the opposite side of the liquid chamber gradually deteriorates.

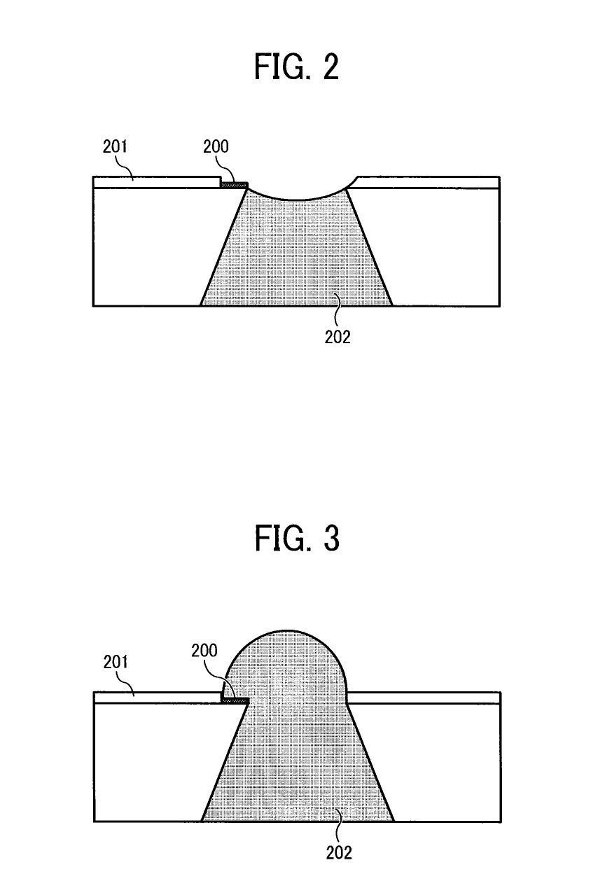

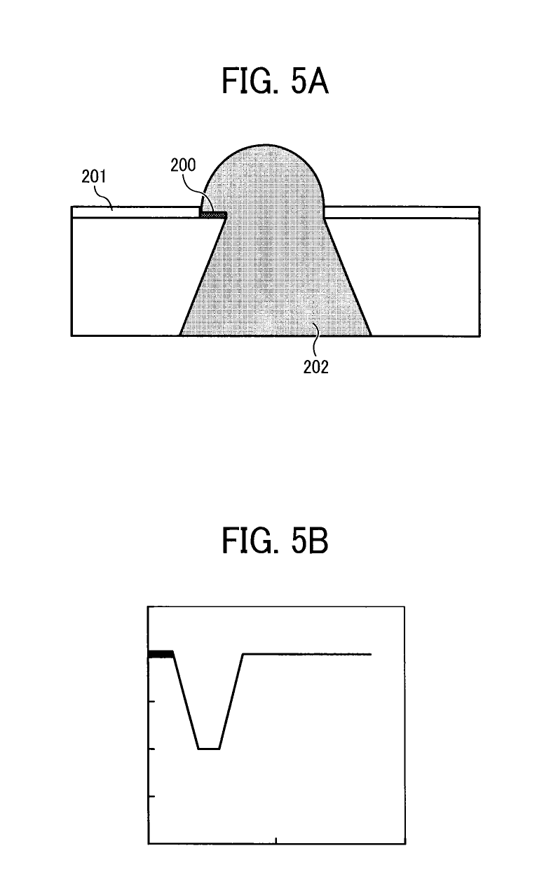

A meniscus is formed inside the nozzle of the head filled with ink. Normally (stationary condition), the meniscus forms a bridge on the side of a liquid chamber with a nozzle edge as a reference point. The deterioration of the nozzle repellent film has little impact (refer to FIG. 2). In FIG. 2, the reference numeral 200 represents a degraded repellent film and the reference numerals 201 and 202, a repellent film and ink, respectively. The same is true in FIGS. 3 to 11. In addition, in the graphs of FIG. 5B to FIG. 11B, the portions in bold represents waveform elements of the drive pulses (discharging pulse). In addition, in the graphs of FIGS. 5B to 11B, X axis represents time and Y axis represents voltage.

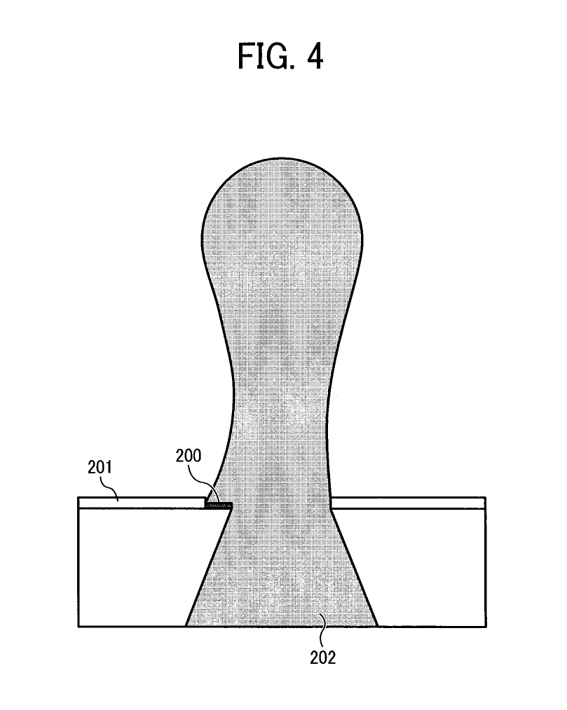

However, as illustrated in FIGS. 3 and 4, if a phenomenon of ink sticking out toward the outside of the nozzle occurs, such that meniscus overflows after the liquid droplet of the ink 202 is discharged, the meniscus forms an asymmetric form because of the degraded nozzle repellent film (refer to FIG. 3). This phenomenon of meniscus overflowing includes, for example, when liquid droplets are discharged, flow-in of ink from the common liquid chamber caused by an outward flow of the ink from the nozzle does not stop soon, which causes meniscus overflowing of the ink at the nozzle. In particular, the more the waveform having a large discharging amount per unit of time to discharge large droplets in a single print cycle, the larger the meniscus overflowing. Also, meniscus of a nozzle overflows immediately after high frequency drive. That is, this phenomenon occurs when flow-in of ink from the common liquid chamber caused by an outward flow of a large amount of ink by high frequency drive does not stop soon, which causes overflowing meniscus of the ink at the nozzle. Also, meniscus overflowing occurs in the case of a re-fill cycle Rf different from the inherent oscillation cycle Tc of the liquid chamber. If liquid droplets are discharged while the meniscus is asymmetric, deviation of the liquid droplet occurs.

As illustrated in FIGS. 5A and 5B to 7A and 7B, in a typical discharging pulse, when the droplet is discharged while meniscus overflowing is occurring, the ink overflown on the degraded repellent film is not sufficiently drawn in. For this reason, the ink overflown remains even just before the droplet is discharged, which causes deviation of the droplet.

FIGS. 5B, 6B, and 7B respectively represent drive pulses in the states illustrated in FIGS. 5A, 6A, and 7A.

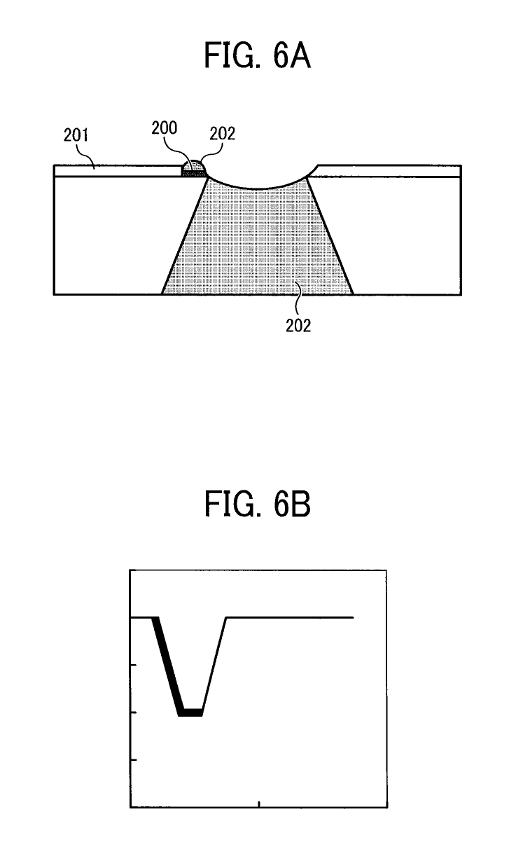

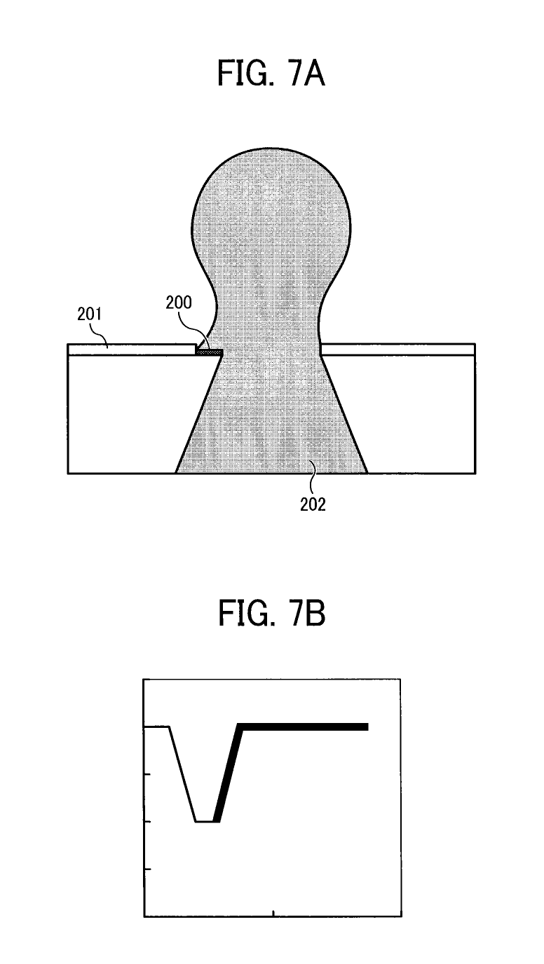

This is described in detail. In the state where meniscus overflowing occurs (refer to FIG. 5A), if the meniscus is drawn in the nozzle by a pulse, some of the ink 202 remains on the repellent film 200 degraded as illustrated in FIG. 6A. Thereafter, if the ink 202 is discharged through the nozzle by a discharging pulse to discharge the ink 202 through the nozzle in a state where the ink 202 remains on the repellent film 200 degraded, the ink 202 remaining on the repellent film 200 degraded and the ink 202 discharged are united, causing deviation of the liquid droplet as illustrated in FIG. 7A.

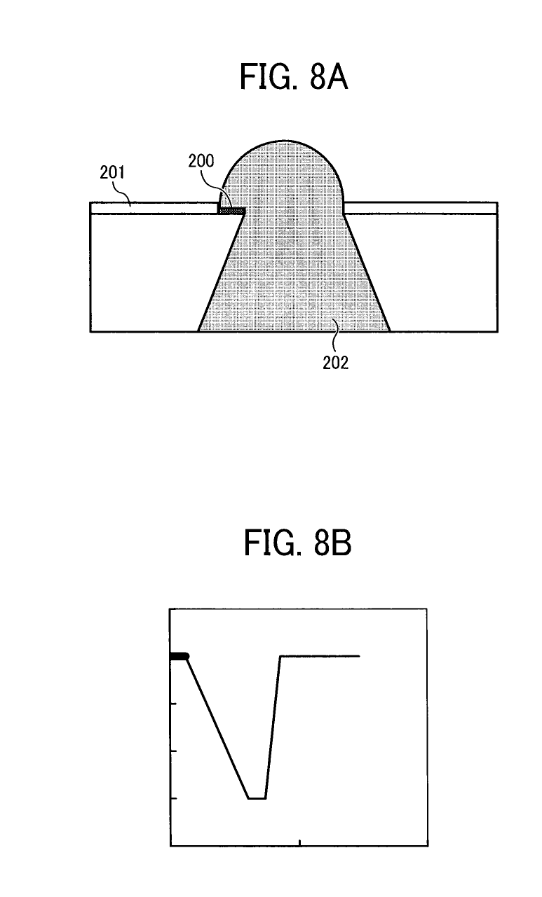

On the other hand, in the present disclosure, as illustrated in FIGS. 8A and 8B to 11A and 11B, the meniscus is slowly drawn in. For this reason, the ink 202 does not remain on the degraded repellent film 200. Namely, it is possible to prevent deviation of liquid droplets.

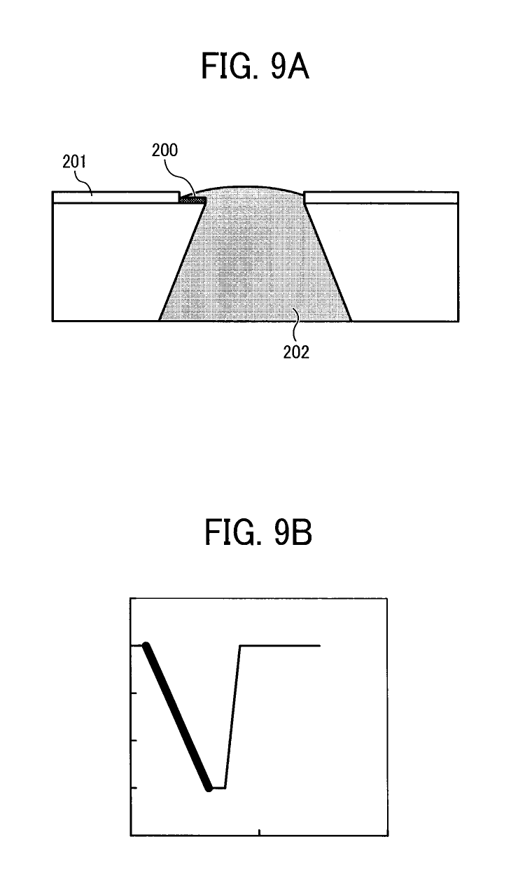

The reason why the deviation of liquid droplets are prevented is described below in detail. When drawing in the meniscus into a nozzle by a pulse in the state of meniscus overflowing (refer to FIG. 8A), a waveform element (the voltage changing part of rising down illustrated in FIG. 9) is used which has a relatively slow changing rate having one third or more of the resonance period (time) of the liquid chamber. That is, the inflation waveform (voltage changing part to draw in ink) having a voltage changing time (also referred to as elapsed time) having one third or more of the resonance period of the liquid chamber is applied to the pressure generating device to inflate the liquid chamber, so that the ink overflowing from the nozzle is drawn in in the nozzle.

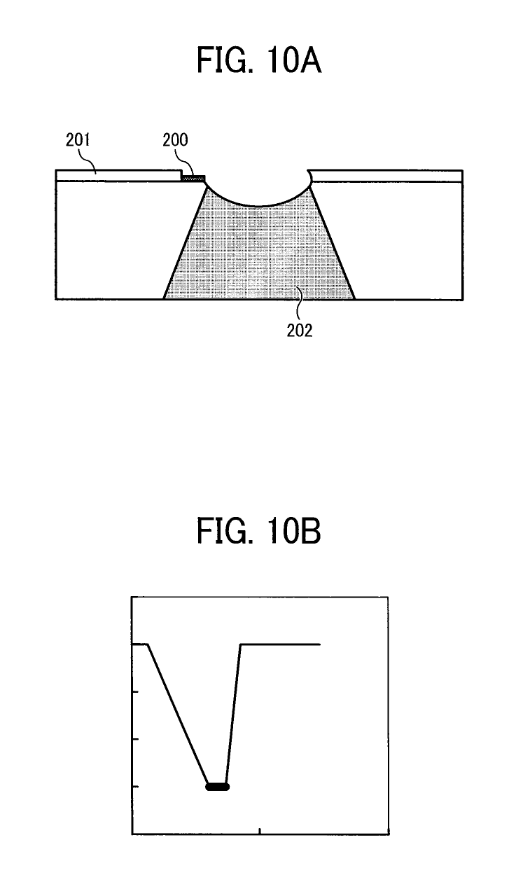

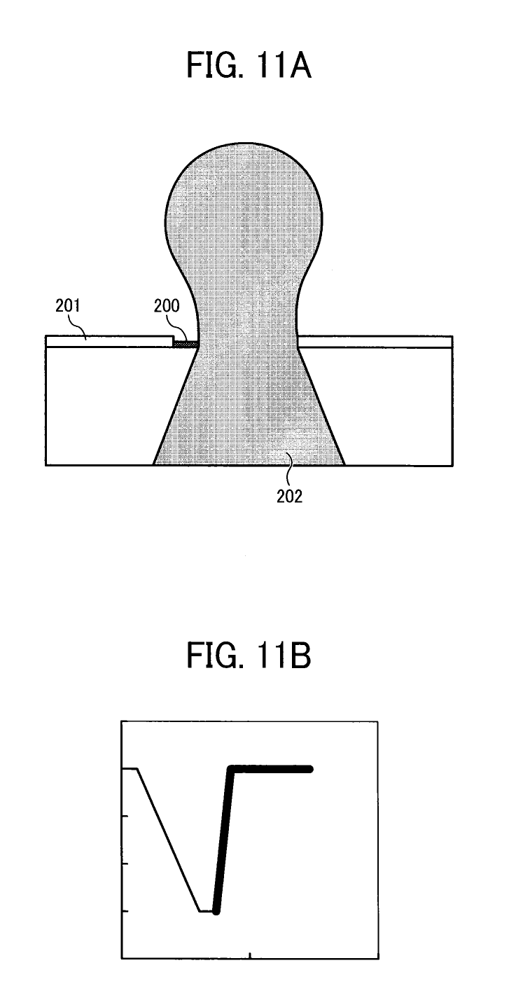

Therefore, the ink 202 remaining on the degraded repellent film 200 has a long draw-in time and moves slowly. For this reason, the meniscus can be drawn in into the nozzle with no ink 202 remaining on the degraded repellent film (Refer to FIG. 10A). Thereafter, when the ink 202 is discharged by the rise-up waveform element (waveform element to contract the liquid chamber) from this state, no deviation of liquid droplets occurs (refer to FIG. 11A).

In the present specification, “pulse” also means a signal sharply changing in a short time.

Also, each of the pulses illustrated in FIGS. 6B and 9B is a draw-in pulse.

The ink for use in the present disclosure has such a low static surface tension of from 18.0 to 27.0 mN/m at 25 degrees C. Such ink soon wet-spreads after the ink lands on a recording medium, quickly permeates into the recording medium, and demonstrates good coloring. Therefore, the quality of an image tends to be good. However, the ink easily wet-spreads on the surface of a nozzle plate, which makes it difficult to secure continuous discharging stability. In particular, since the portion where a repellent film is peeled off has a smaller contact angle than the repellent film, the ink tends to stick to the surface of the nozzle plate. This means that if ink overflows from the surface of a nozzle plate, the overflown droplet does not peeled off easily even when discharged droplets thereafter draws the overflown droplet. For this reason, the meniscus at the nozzle hole becomes uneven, which is disadvantageous in terms of discharging stability.

Therefore, the ink wet-spreading far away from the nozzle hole portion remains on the surface of the nozzle plate. Therefore, the remnants of the ink gradually accumulates and affects discharging in the end.

According to the present disclosure, an inflation waveform element (voltage changing portion to draw in ink) of the voltage changing time having one third or more of the resonance period of a liquid chamber is applied to slowly draw in the meniscus inside the nozzle. Therefore, even the remnant of the ink, which has wet-spread far away from the nozzle hole and cannot be drawn-in by an inflation waveform element in a short time, can be drawn-in into the meniscus in such a long drawing-in time. Therefore, the overflown ink is almost all retrieved and the impact on discharging due to the overflown ink is substantially canceled. As a result, images having high quality can be obtained.

Slow drawing-in of a meniscus into a nozzle is advantageous to suppress vibration of large droplets in comparison with drawing-in of a meniscus in separate occasions. In the case of large droplets, the number of pulses in a single print frequency tends to be large and remaining vibration tends to be strong. To suppress this, it is extremely good to slowly draw in a meniscus.

According to the present disclosure, when the inflation waveform element (voltage changing portion to draw in ink) is set to have a voltage changing time of one third or more of the resonance period of the liquid chamber of a head, meniscus is stably formed and also discharging is stabilized.

It is preferably 1/3 to 1/1 of the resonance period of the liquid chamber in a head and particularly preferably 1/1 of the resonance period of the liquid chamber in a head.

The preferable reason why the voltage changing time of the inflation waveform element is set as above is that when it is equal to one fourth of the acoustic resonance period of the liquid chamber in a head, the phase of the remaining vibration of the discharging pulse just before and the phase of the pressure wave of the inflation waveform element are reverse, thereby suppressing overlapping of the two pressure waves. For this reason, the next discharging pulse fails to discharge the ink at required discharging speed. As the voltage changing time of the inflation waveform element becomes longer than 1/4 of the acoustic resonance period of the liquid chamber in a head, the degree of overlapping is improved. If the voltage changing time is not less than 1/3, the overlapping state is good.

Due to the inflation waveform element, the ink in the vicinity of the nozzle discharging hole is drawn in into the nozzle, a meniscus is formed at a predetermined position.

“Vicinity” means periphery of a nozzle hole.

“Predetermined position” at the time when a meniscus is formed means a regular position where the meniscus is formed. For the cross-section of the hole of the nozzle plate, a meniscus is formed at a position of a state forming a concave portion as to the reference surface of the nozzle plate. A meniscus is not formed at a regular position when the meniscus overflowing occurs.

According to the present disclosure, an inkjet recording method is provided which is capable of stably discharging ink having a low static surface tension and obtaining images with high quality. This is significant when a repellent film on a nozzle plate has degraded.

According to the present disclosure, one or more drive pulse is applied to the pressure generating device in a single print cycle to discharge one or more droplets of ink. It is preferable that, in the drive pulse forming the first droplet therein, the voltage changing time of the inflation waveform element be one third or more of the resonance period of the liquid chamber.

“Single print unit cycle” means, for example, a time interval during which each actuator forms each dot on a medium.

“Single print unit cycle” includes the discharging pulse (drive pulse).

Refer to Japanese unexamined patent application No. 2001-146011, Japanese unexamined patent application No. H10-81012, Japanese unexamined patent application No. 2011-062821, etc.

For example, an inkjet recording device is disclosed in Japanese unexamined patent application No. H10-81012, which discharges multiple ink droplets from each nozzle of an inkjet head in a single print cycle for forming a single dot on a recording medium to form the single dot by the multiple ink droplets.

The inkjet recording device includes a liquid chamber to accommodate ink, a nozzle plate having nozzles communicating with the liquid chamber, an inkjet head having an actuator (pressure generating device) to apply a pressure to the ink in the liquid chamber in order to discharge droplets of the ink through the nozzle due to the piezoelectric effect of a piezoelectric element, a drive waveform generating unit to generate a drive waveform including a drive pulse, a head driver to select the drive pulse from the drive waveform to generate a discharging pulse and apply the discharging pulse to the actuator, and a relatively moving device to relatively move the inkjet head for a recording medium.

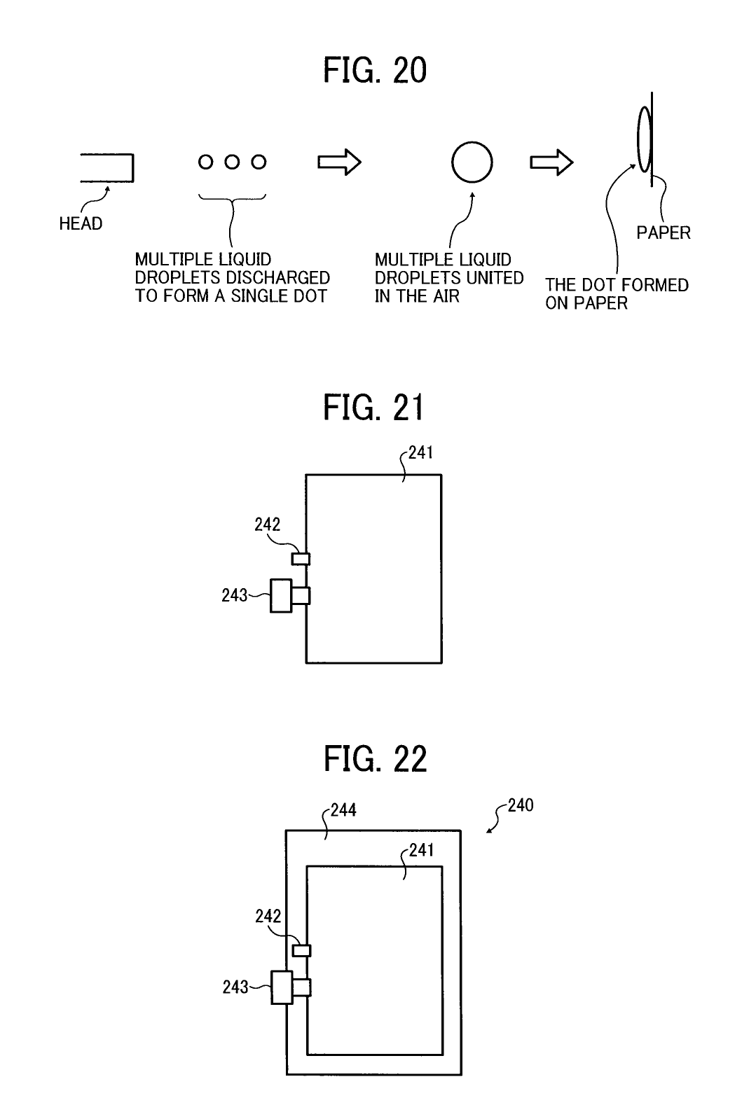

As illustrated in FIG. 20, when the relatively moving device moves the inkjet head and the recording medium relatively from each other, a single or multiple drive pulses (discharging pulses) are supplied to the actuator in the single print cycle to discharge a single or multiple ink droplet.

The multiple ink droplets discharged form a single ink dot on the recording medium.

Such dots are disposed on the recording medium so that a predetermined image is formed thereon.

When the number of ink droplets discharged in the print unit cycle is adjusted, the gradation and the size of dots are adjusted, which makes it possible to conduct multi-grade printing.

In the present disclosure, it is possible to have any of a configuration in which after the droplets contained in the single print cycle are united in the air, the united droplets are attached to a recording medium, another configuration in which the droplets contained in the single print cycle are attached to a recording medium according to the sequence of the discharging sequence, or yet another configuration in which only a single droplet is attached.

Of these, the configuration in which after the droplets contained in the single print cycle are united in the air, the united droplets are attached to a recording medium is preferable in terms that the form of ink is close to a circle and the ink droplet does not deviate from the position where the droplets should be attached.

At this point in time, if the inflation waveform element to form the first droplet is set to be the long voltage changing time described above, the remnant of ink accumulating on the nozzle plate is retrieved and the meniscus of the first droplet is formed even. Also, it is possible to cancel the impact on meniscus forming by the second droplet and the later droplets (in the same single print cycle) formed immediately after the first droplet. The inflation waveform element having the long voltage changing time described above is applied to only the discharging pulse forming the first droplet. It is also possible to enter a particular inflation waveform element for the discharging pulses for the second droplet and the droplets thereafter. However, taking into account drawing-in a meniscus takes a time, the velocity of the waveform is not earned, which makes entering the particular waveform not practical.

Ink

The ink mentioned above has a static surface tension of from 18.0 to 27.0 mN/m at 25 degrees C.

The static surface tension of from 18.0 to 27.0 mN/m at 25 degrees C. is advantageous in terms of prevention of bleed of the ink on a recording medium and discharging stability thereof.

The surface tension can be measured at 25 degrees C. by a platinum plate method using a fully-automatic surface tensiometer (CBVP-Z, manufactured by Kyowa Interface Science Co., Ltd.).

There is no specific limitation to make the static surface tension of the ink within the range and such a method can be suitably selected to suit to a particular application. For example, it is possible to adjust the static surface tension by changing the addition amount of a surfactant and a permeating agent of ink, the kind of surfactant, etc.

The ink contains, for example, at least water, a water-soluble organic solvent, a surfactant, and a colorant, and other optional components based on a necessity basis.

Colorant

As the colorant, dyes, pigments, etc. can be used. Pigments are preferable in terms of water resistance and light resistance of ink recorded matter. Examples of the pigment are organic pigments and inorganic pigments. These can be used alone or in combination.

Specific examples of the organic pigments include, but are not limited to, azo-based pigments, phthalocyanine-based pigments, anthraquinone-based pigments, dioxazine-based pigments, indigo-based pigments, thio-indigo-based pigments, perylene-based pigments, isoindolinone-based pigments, aniline black, azomethine-based pigments, and rhodamine B lake pigments.

Specific examples of the inorganic pigments include, but are not limited to, carbon black, iron oxide, titanium oxide, calcium carbonate, barium sulfate, aluminum hydroxide, barium yellow, indigo, cadmium red, chrome yellow, and metal powder.

Specific examples of the black pigment include, but are not limited to, carbon black (C.I. Pigment Black 7) such as furnace black, lamp black, acetylene black, and channel black, metals such as copper oxides, iron oxides (C.I. Pigment Black 11), and titanium oxides, and organic pigments such as aniline black (C.I. Pigment Black 1).

Specific examples of the yellow pigment include, but are not limited to, C.I. Pigment Yellow 1 (fast yellow G), 2, 3, 12 (disazo yellow AAA), 13, 14, 16, 17, 20, 23, 24, 34, 35, 37, 42 (yellow iron oxides), 53, 55, 73, 74, 75, 81, 83 (disazo yellow HR), 86, 93, 95, 97, 98 100, 101, 104, 108, 109, 110, 114, 117, 120, 125, 128, 129, 137, 138, 139, 147, 148, 150, 151, 153, 154, 155, 166, 168, 180, and 185.

Specific examples of the magenta pigments include, but are not limited to, C.I. Pigment Violet 19, C.I. Pigment Red 1, 2, 3, 5, 7, 9, 12, 17, and 22 (brilliant fast scarlet), 23, 31, 38, 48:1 [permanent red 2B(Ba)], 48:2 [Permanent Red 2B (Ca)], 48:3 [Permanent Red 2B(Sr)], 48:4 [Permanent Red 2B(Mn)], 49:1, 52:2, 53:1, 57:1 (Brilliant Carmine 6B), 60:1, 63:1, 63:2, 64:1, 81 (Rhodamine 6G Lake), 83, 88, 92, 97, 101 (rouge), 104, 105, 106, 108 (cadmium red), 112, 114, 122 (dimethyl quinacridone), 123, 146, 149, 166, 168, 170, 172, 175, 176, 178, 179, 180, 184, 185, 190, 192, 193, 202, 209, 215, 216, 217, 219, 220, 223, 226, 227, 228, 238, 240, 254, 255, and 272.

Specific examples of the cyan pigment include, but are not limited to, C.I. Pigment Blue 1, 2, 3, 15 (copper phthalocyanine blue R), 15:1, 15:2, 15:3 (copper phthalocyanine blue G), 15:4, 15:6 (phthalocyanine blue E), 16, 17:1, 22, 56, 60, 63, and 64, Pat blue 4, and Pat blue 60.

Specific examples of intermediate color pigment include, but are not limited to, C.I. Pigment Red 177, 194, and 224, C.I. Pigment Orange 16, 36, 43, 51, 55, 59, 61, and 71, C.I. Pigment Violet 3, 19, 23, 29, 30, 37, 40, and 50, and C.I. Pigment Green 7 and 36 for red, green and blue.

The ink for use in the present disclosure may contain polymer particulates containing a hydrophobic dye or pigment as the colorant to improve print density and print durability. The polymer particulate is used as a dispersion. Of these, dispersions of the polymer particulate containing a pigment, in particular an organic pigment or carbon black are more preferable. Specific examples of the polymer for use in the dispersion of the polymer particulate containing the pigment include, but are not limited to, vinyl-based polymers, polyester-based polymers, and polyurethane-based polymers. Of these, vinyl-based polymers are preferable.

Polymers obtained by co-polymerizing a monomer composition containing (a): at least one kind of vinyl-based monomer selected from the group consisting of acrylic acid esters, methacrylic acid esters, and styrene-based monomers, (b): a polymerizable unsaturated monomer having a salt-producing group, and (c): a component copolymerizable with the vinyl-based monomer and the polymerizable unsaturated monomer having a salt-producing group are preferable as the vinyl-based polymer.

As the vinyl-based monomer of (a), specific examples thereof include, but are not limited to, acrylic acid esters such as methylacrylate, ethylacrylate, isopropylacrylate, n-butylacrylate, t-butylacrylate, isobutylacrylate, n-amylacrylate, n-hexylacrylate, n-octylacrylate, t-butyln-octylacrylate, isobutylacrylate, n-amylacrylate, n-hexylacrylate, n-octylacrylate, and dodecylacrylate; methacrylic acid esters such as methylmethactylate, isopropylmethactylate, n-butylmethactylate, t-butylmethactylate, isobutylmethactylate, n-amylmethactylate, 2-ethylhexylmethactylate, and laurylmethactylate; and styrene-based monomers such as styrene, vinyltoluene, and 2-methylstyrene. These can be used alone or in combination.

As the polymerizable unsaturated monomer having a salt-producing group, examples thereof are cationic monomers having a salt-producing group and anionic monomers having a salt-producing group.

As the cationic monomers having a salt-producing group, examples thereof are tertiary amine-containing unsaturated monomers and ammonium salt-containing unsaturated monomers. Preferred specific examples thereof include, but are not limited to, N,N-diethylaminoethylacrylate, N—(N′,N′-dimethylaminoethyl)acrylamide, vinyl pyridine, 2-methyl-5-vinylpyridine, dimethylaminoethyl methacrylate, and diethylaminoethyl methacrylate.

As the anionic monomer having the salt-producing group, examples thereof are unsaturated carboxylic acid monomers, unsaturated sulfonic acid monomers, and unsaturated phosphoric acid monomers. Specific examples of the anionic monomer having the salt-producing group include, but are not limited to, acrylic acid, methacrylic acid, itaconic acid, fumaric acid, and maleic acid.

As the component copolymerizable with the vinyl-based monomer and the polymerizable unsaturated monomer including a salt producing group, examples thereof are acrylamide-based monomers, methacrylamide-based monomers, hydroxyl group containing monomers, and macromers having polymerizable functional groups at one end.

There is no specific limitation to macromers having polymerizable functional groups at one end and it can be suitably selected to suit to a particular application. Examples thereof are silicone macromers, styrene-based macromers, polyester-based macromers, polyurethane-based macromers, polyalkyl ether macromers, and macromers represented by the chemical formula: CH₂═C(R⁵)COO(R⁶O)ₚR⁷ (in the chemical formula, R⁵ represents a hydrogen atom or a lower alkyl group, R⁶ represents a divalent hydrocarbon group having 1 to 30 carbon atoms allowed to have a hetero atom, R⁷ is a monovalent hydrocarbon group having 1 to 30 carbon atoms allowed to have a hydrogen atom or hetero atom, and p represents an integer of from 1 to 60). These can be used alone or in combination.

Specific examples of the lower alkyl group in the Chemical formula include, but are not limited to, alkyl groups having one to four carbon atoms.

Specific examples of the hydroxyl group containing monomer include, but are not limited to, 2-hydroxyethyl acrylate and 2-hydroxyethyl methacrylate.

The macromer represented by the chemical formula CH₂═C(R⁵)COO(R⁶O)ₚR⁷ are preferably polyethylene glycol (meth)acrylate (2 to 30 carbon atoms) and methoxypolyethylene glycol (meth)acrylate (1 to 30 carbon atoms). In the present disclosure, (meth)acrylate represents acrylate or methacrylate.

Of the copolymerizable component, the macromer is preferable. Silicone macromers, styrene-based macromers, and polyalkylether macromers are preferable.

There is no specific limitation to the proportion of the vinyl-based monomer in the monomer composition and it can be suitably selected to suit to a particular application. It is preferably from 1 to 75 percent by mass, more preferably from 5 to 60 percent by mass, and furthermore preferably from 10 to 50 percent by mass to improve the dispersion stability of a polymer emulsion.

There is no specific limitation to the proportion of the polymerizable unsaturated monomer having a salt-producing group in the monomer composition and it can be suitably selected to suit to a particular application. It is preferably from 2 to 40 percent by mass and more preferably from 5 to 20 percent by mass to improve the dispersion stability of a polymer emulsion.

There is no specific limitation to the proportion of the vinyl-based monomer and the polymerizable unsaturated monomer having a salt-producing group in the monomer composition and it can be suitably selected to suit to a particular application. It is preferably from 5 to 90 percent by mass, more preferably from 10 to 85 percent by mass, and particularly preferably from 20 to 60 percent by mass to improve the dispersion stability of a polymer emulsion.

The proportion of the polymer particulate is preferably from 10 to 40 percent by mass to the total prescription of ink.

The average particle diameter of the polymer particulate is preferably from 20 to 200 nm in terms of dispersion stability.

The average particle diameter is, for example, the 50 percent average particle diameter (D50) obtained by measuring at 23 degrees C. a sample prepared by dilution with a pure water such that the concentration of the pigment in the measuring sample is 0.01 percent by mass by using Microtrac UPA-150 (manufactured by Nikkiso Co., Ltd.) with a particle refractive index of 1.51, a particle density of 1.4 g/cm³, and pure water parameters as the solvent parameter.

Surfactant

Of these, it is preferable to select a surfactant that has a low surface tension, a high permeability, and an excellent leveling property without degrading dispersion stability of the colorant irrespective of the kind of the colorant and the combinational use with the water-soluble organic solvent.

As the surfactant, it is preferable to select at least one surfactant from the group consisting of anionic surfactants, nonionic surfactants, silicone-containing surfactants, and fluoro surfactants. Of these, silicone-containing surfactant and fluoro surfactants are particularly preferred. These surfactants can be used in combination.

The fluorine surfactant in which the number of carbon atoms substituted with fluorine atoms is from 2 to 16 is preferable and, 4 to 16, more preferable. When the number of carbon atoms substituted with fluorine atoms is within this range, the effect of fluorine is obtained and storage property of ink is good.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. Of these, polyoxyalkylene ether polymer compounds having a perfluoroalkyl ether group in its side chain are particularly preferable because of its low foaming property.

The fluoro surfactant represented by the following chemical formula I is more preferable.

CₙF₂ₙ₊₁—CH₂CH(OH)CH₂—O—(CH₂CH₂O)ₐ—Y′ Chemical formula I

In the chemical formula I, “n” represents an integer of from 2 to 6, “a” represents an integer of from 15 to 50, “Y”” represents —C_{b}H_{2b+i} (where “b” represents an integer of from 11 to 19), or —CH₂CH(OH)CH₂—C_{d}F_{2d+l} (where, d represents an integer of from 2 to 6).

Any suitably synthesized fluoro surfactant and products available on the market are also usable. Of these, in terms of print quality, in particular coloring and uniform dying property for paper, FS-300 (manufactured by E. I. du Pont de Nemours and Company), FTERGENT FT-110, FT-250, FT-251, FT-400S, FT-150, and FT-400SW (all manufactured by NEOS COMPANY LIMITED), and POLYFOX PF-151N (manufactured by OMNOVA SOLUTIONS INC.).

Specific examples of the fluoro surfactant include, but are not limited to, the following:

### (1) Anionic Fluoro Surfactant

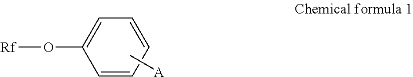

In the Chemical formula 1 illustrated above, Rf represents a mixture of a fluorine-containing hydrophobic group represented by the following Chemical formula 2. A symbol “A” represents —SO₃X, —COOX, or —PO₃X, where “X” represents a counter cation. Specific examples of “X” include, but are not limited to, Li, Na, K, NH₄, NH₃CH₂CH₂OH, NH₂(CH₂CH₂OH)₂, and NH(CH₂CH₂OH)₃.

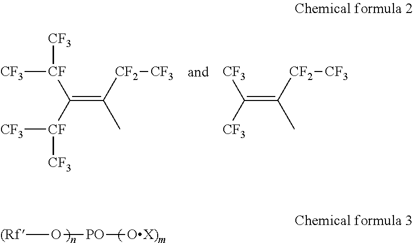

In the Chemical formula 3 illustrated above, “Rf” represents a fluorine-containing group represented by the following chemical formula X. “X” represents the same as above. A symbol “n” is 1 or 2 and a symbol “m” is 2−n.

FCF₂CF₂ₙCH₂CH₂— Chemical formula 4

In the chemical formula 4, “n” represents an integer of from 3 to 10.

Rf′—S—CH₂CH₂—COO—X Chemical formula 5

In the Chemical formula 5 illustrated above, “Rf” and “X” are the same as above.

Rf′—SO₃—X Chemical formula 6

In the Chemical formula 6 illustrated above, “Rf” and “X” are the same as above.

### (2) Nonionic Fluoro Surfactant

Rf—OCH₂CH₂OₙH Chemical formula 7

In the Chemical formula 7 illustrated above, Rf is the same as above. The symbol “n” represents an integer of from 5 to 20.

Rf′—OCH₂CH₂OₙH Chemical formula 8

In the Chemical formula 8 illustrate above, “Rf” represents the same as above. The symbol “n” represents an integer of from 1 to 40.

CF₃CF₂(CF₂CF₂)ₘ—CH₂CH₂O(CH₂CH₂O)ₙH Chemical formula 9

In the chemical formula 9, “m” represents 0 or an integer of from 1 to 10 and “n” represents 0 or an integer of from 1 to 40.

### (3) Amphoteric Fluoro Surfactant

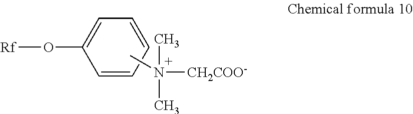

In the Chemical formula 10 illustrated above, “Rf” is the same as above.

### (4) Oligomer Type Fluoro Surfactant

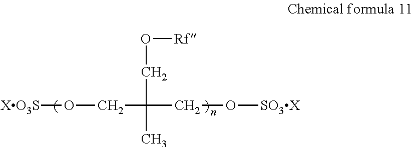

In the Chemical formula 11 illustrated above, “Rf” represents a fluorine-containing group represented by the following Chemical formula 12. The symbol “n” represents an integer of from 1 to 10. The symbol“X” represents the same as above.

FCF₂CF₂ₙCH₂— Chemical formula 12

In the chemical formula 12, “n” represents an integer of from 1 to 4.

There is no specific limitation to the silicone-based surfactant and it can be suitably selected to suit to a particular application. Of these, silicone-based surfactants which are not dissolved in a high pH are preferable. Specific examples thereof include, but are not limited to, side chain-modified polydimethyl siloxane, both end-modified polydimethyl siloxane, one end-modified polydimethyl siloxane, and side chain both end-modified polydimethyl siloxane. Of these, polyether-modified silicon-based surfactants having a polyoxyethylene group or polyoxyethylene polyoxypropylene group as the modification group are particularly preferable because these demonstrate good properties as aqueous surfactants.

Any suitably synthesized surfactant and products available on the market are also usable. Products available on the market are easily obtained from Byc Chemie Japan Co., Ltd., Shin-Etsu Silicone Co., Ltd., Dow Corning Toray Co., Ltd., etc.

There is no specific limitation to the polyether-modified silicon-containing surfactant and it can be suitably selected to suit to a particular application. For example, a compound represented by the following chemical formula 13 in which a polyalkylene oxide structure is introduced into the side chain of the Si site of dimethyl polysilooxane.

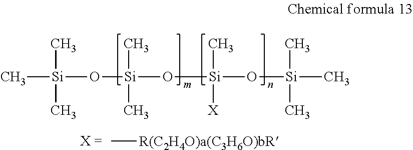

In the Chemical formula 13 illustrated above, “m”, “n”, “a”, and “b” independently represent integers. In addition, “R” and “R′” each, independently represent alkyl groups and alkylene groups.

Any suitably synthesized polyether-modified silicone-containing surfactant and products available on the market are also usable. Specific examples of the product include, but are not limited to, KF-618, KF-642, and KF-643 (all manufactured by Shin-Etsu Chemical Co., Ltd.), BYK-345, BYK-347, BYK-348, and BYK-349 (all manufactured by BYK Japan KK.).

Specific examples of the anionic surfactants include, but are not limited to, polyoxyethylene alkylether acetates, dodecyl benzene sulfonates, laurates, and salts of polyoxyethylene alkylether sulfates.

Any suitably synthesized anionic-based surfactant and products available on the market are also usable. Specific examples of the product include, but are not limited to polyoxyethylene (3) tridecylether sodium acetate (ECTD-3NEX, manufactured by Nikko Chemicals Co., Ltd.)

Specific examples of the nonionic surfactant include, but are not limited to, polyoxyethylene alkylether, polyoxypropylene polyoxyethylene alkylether, polyoxyethylene alkylesters, polyoxy ethylene sorbitan aliphatic esters, polyoxyethylene alkylphenylethers, polyoxyethylene alkylamines, and polyoxyethylene alkylamides.

In addition, the proportion of the surfactant is not particularly limited and it can be suitably selected to suit to a particular application. It is preferably from 0.01 to 3.0 percent by mass and more preferably from 0.03 percent by mass to 2.0 percent by mass to the total content of ink. When the proportion is in the range of from 0.01 to 3.0 percent by mass, the effect of adding a surfactant is obtained, moderate permeability to a recording medium is obtained, no degradation of the image density or no strike-through occurs.

Water-Soluble Organic Solvent

The water-soluble organic solvent is added to prevent drying of ink and improve dispersion stability thereof.

Specific examples of the water-soluble organic solvent include, but are not limited to, polyols, polyol alkylethers, polyol arylethers, nitrogen-containing heterocyclic compounds, amides, amines, sulfur-containing compounds, propylene carbonates, and ethylene carbonates. These can be used alone or in combination.

Specific examples of the polyols include, but are not limited to, ethylene glycol, diethylene glycol, triethylene glycol, tetraethylene glycol, polyethylene glycol, propylene glycol (1,2-propane diol), dipropylene glycol, tripropylene glycol, polypropylene glycol, 1,2-butanediol, 1,3-butanediol, 3-methyl-1,3-butanediol, 1,5-pentane diol, 1,6-hexane diol, glycerine, trimethylol ethane, trimethylol propane, 1,2,3-butanetriol, 1,2,4-butanetriol, 1,2,6-hexane triol, and petryol.

Specific examples of the polyol alkylethers include, but are not limited to, ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether.

Specific examples of the polyol arylethers include, but are not limited to, ethylene glycol monophenylether and ethylene glycol monobenzylether.

Specific examples of nitrogen-containing heterocyclic compounds include, but are not limited to, 2-pyrolidone, N-methyl-2-pyrolidone, N-hydroxyethyle-2-pyrolidone, 1,3-dimethylimidazoline, ε-caprolactam, and γ-butylolactone.

Specific examples of the amides include, but are not limited to, formamide, N-methylformamide, and N,N-dimethylformamide.

Specific examples of the amines include, but are not limited to, monoethanol amine, diethanol amine, triethanol amine, monoethyl amine, diethylamine, and triethyl amine. Specific examples of the sulfur-containing compounds include, but are not limited to, dimethyl sulphoxide, sulfolane, and thiodiethanol.

In addition to the water-soluble organic solvents mentioned above, other wetting agents are also suitable. Such a wetting agent preferably contains a urea compound and a sugar.

Specific examples of the sugar groups include, but are not limited to, monosaccharides, disaccharides, oligosaccharides (including trisaccharides and tetrasaccharides), and polysaccharides.

Specific examples thereof include, but are not limited to, glucose, mannose, fructose, ribose, xylose, arabinose, galactose, maltose, cellobiose, lactose, saccharose, trehalose, and maltotriose. Polysaccharides represent sugar in a broad sense and contain materials that are present widely in nature, for example, α-cyclodextrine and cellulose.

In addition, specific examples of derivatives of these sugar groups include, but are not limited to, reducing sugars (for example, sugar alcohols represented by HOCH₂(CHOH)ₙCH₂OH, where n represents an integer of from 2 to 5) of the sugar groups specified above, oxidized sugars (e.g., aldonic acid and uronic acid), amino acid, and thio acid. Of these, sugar alcohols are preferable.

Specific examples of the sugar alcohol include, but are not limited to, D-sorbitol, sorbitan, maltitol, erythritol, lactitol, and xylitol.

To manufacture ink having excellent storage stability and discharging stability, as the water-soluble organic solvent, glycerin, diethylene glycol, triethylene glycol, propylene glycol (1,2-propane diol), dipropylene glycol, 1,3-butane diol, 1,2-butane diol, 3-methyl-1,3-butane diol, 1,5-pentane diol, 1,6-hexanediol, trimethylol propane, tetramethylol propane, D-sorbitol, and xylitol are preferable. Glycerin, 3-methyl-1,3-butane diol, 3-butane diol, 1,2-butane diol, propylene glycol (1,2-propane diol), 1,6-hexanediol, 1,5-pentane diol, and 2-pyrrolidone are more preferable.

In the case of pigment ink, the mass ratio of the pigment to the water-soluble organic solvent has a significant impact on the discharging stability of ink discharged from a head. If the ratio of the water-soluble organic solvent is small while the ratio of the solid pigment portion is large, water evaporation around ink meniscus of the nozzle tends to be accelerated, thereby causing poor discharging performance.

There is no specific limitation to the proportion of the water-soluble organic solvent and it can be suitably selected to suit to a particular application. It is preferably from 10 to 50 parts by weight to the total content of ink.

Water

As the water, deionized water, ultrafiltered water, reverse osmosis water, pure water such as distilled water, and ultra pure water can be used.

The content of the water has no particular limit and can be suitably selected to suit to a particular application.

Other Components

The other optional components are not particularly limited and can be suitably selected to suit to a particular application. Examples thereof are a foam inhibitor (defoaming agent), a pH regulator, a preservatives and fungicides, a corrosion inhibitor, a chelate agent, and a permeating agent.

The foam inhibitor (defoaming agent) is added to prevent foaming of ink or break foams. An example of the foam inhibitor (defoaming agent) is represented by the following chemical formula 14.

HOR₁R₃C—(CH₂)ₘ—CR₂R₄OH Chemical formula 14

In the chemical formula 14, “R₁” and “R₂” each, independently represent alkyl groups having 3 to 6 carbon atoms. “R₃” and “R₄” each, independently represent alkyl groups having 1 to 2 carbon atoms. The symbol “m” represents an integer of from 1 to 6.

Of the compounds represented by the chemical formula 14, 2,4,7,9-tetramethyl decane-4,7-diol is preferable because it demonstrates excellent foam suppressing property.

As the defoaming agent, silicone defoaming agent is preferable. Examples of the silicone defoaming agent are oil type silicone defoaming agent, compound type silicone defoaming agent, self-emulsification type silicone defoaming agent, emulsion type silicone defoaming agent, and modified silicone defoaming agent.

The defoaming agent is also available on the market. Specific examples of the defoaming agent include, but are not limited to, silicone defoaming agent (KS508, KS531, KM72, KM72F, KM85, and KM98, manufactured by Shin-Etsu Chemical CO., LTD.), silicone defoaming agent (Q2-3183A, SH5500, SH5510, SM5571, SM5571 EMULSION, etc., manufactured by DOW CORNING TORAY CO., LTD.), silicone defoaming agents (SAG30, etc., manufactured by NIPPON UNICAR COMPANY LIMITED), and defoaming agents (ADEKANATE series, manufactured by ADEKA CORPORATION).

The pH regulator is added to keep ink alkali to stabilize the dispersion state and discharging of the ink. However, when pH is 11 or greater, the head of inkjet and an ink supplying unit tends to be dissolved easily, which results in modification, leakage, bad discharging performance of the ink, etc. over an extended period of use depending on the material forming the head or the unit. When the pigment is used as the colorant, it is more desirable to add a pH regulator when the pigment is mixed and kneaded and dispersed together with a dispersant in water than when additives such as a wetting agent and a permeating agent are added after mixing, kneading, and dispersing. This is because such dispersion may be broken depending on the kind of a pH regulator added.

The pH regulator is preferable to contain at least one of an alcohol amine, an alkali metal hydroxide, ammonium hydroxide, a phosphonium hydroxide, and an alkali metal carbonate.

Specific examples of the alcohol amine include, but are not limited to, diethanol amine, triethanol amine, and 2-amino-2-ethyl-1,3-propane diol.

Specific examples of the alkali metal hydroxide include, but are not limited to, lithium hydroxide, sodium hydroxide, and potassium hydroxide.

Specific examples of the hydroxide of ammonium include, but are not limited to, ammonium hydroxide and quaternary ammonium hydroxide.

A specific example of the phosphonium hydroxide is quaternary phosphonium hydroxide.

Specific examples of the alkali metal carbonates include, but are not limited to, lithium carbonate, sodium carbonate, and potassium carbonate.

Specific examples of the preservatives and fungicides include, but are not limited, dehydrosodium acetate, sodium sorbinate, 2-pyridine thiol-1-oxide sodium, sodium benzoate, and pentachlorophenol sodium.

Specific examples of the corrosion inhibitor include, but are not limited to, acid sulfite, thiosodium sulfate, thiodiglycolate ammon, diisopropyl ammonium nitrite, pentaerythritol tetranitrate, and dicyclohexyl ammonium nitrite.

Specific examples of the chelate reagents include, but are not limited to, ethylene diamine sodium tetraacetate, nitrilo soddium triacetate, hydroxyethylethylene diamine sodium tri-acetate, diethylenetriamine sodium quinternary acetate, and uramil sodium diacetate.

Specific examples of the permeating agent include, but are not limited to, diol compounds having 7 to 11 carbon atoms. Specific examples of the diol compound having 7 to 11 carbon atoms include, but are not limited to, 2-ethyl-1,3-hexanediol and 2,2,4-trimethyl-1,3-pentanediol.

The proportion of the permeating agent in the total content of ink is preferably from 1 to 5 percent by mass in terms of storage stability.

There is no specific limitation to viscosity and pH of the ink for use in the present disclosure and they can be suitably selected to suit to a particular application.

Viscosity at 25 degrees C. is preferably from 3 to 20 mPa·s and particularly preferably 6 to 20 mPa·s. Discharging stability and image quality can be excellent in this range. pH is preferably from 7 to 10.

The viscosity of ink can be adjusted by proportion and identification of each solvent and active agent and the content of water. There is no specific limitation to reducing viscosity and it can be suitably selected to suit to a particular application. For example, it is suitable to reduce the addition amount of ink and increase the addition amount of water.

Colorization

There is no specific limitation to the color of each ink for use in the present disclosure and it can be suitably selected to suit to a particular application. For example, yellow, magenta, cyan, and black can be used. When an ink set including at least two kinds of these inks is used for recording, multiple color images can be produced. When an ink set having all the colors is used, full color images can be formed.

Ink Set

It is preferable to use an ink set in addition to the single color ink mentioned above. The ink set preferably satisfies the requisites of the following (1) to (3).

(1) The ink set including black ink and one or more color inks.
(2) Each ink has a static surface tension of from 18.0 to 27.0 mN/m at 25 degrees C.
(3) The difference between the static surface tension of black and the static surface tension of any of the other color inks {(static surface tension of black ink)−(static surface tension of any of the other color inks)} at 25 degrees C. is 0 to 4 mN/m at 25 degrees C.

Ink having a low static surface tension of from 18.0 to 27.0 mN/m at 25 degrees C. soon wet-spreads after the ink lands on a recording medium, quickly permeates into the recording medium, and demonstrates good coloring. Therefore, the quality of an image tends to be good. However, the ink wet-spreads on the surface of a nozzle plate, which makes it difficult to secure continuous discharging stability.

In the case of the ink wide-spreading far away from the nozzle hole as described above, when an inflation waveform element (voltage changing portion to draw in ink) of the voltage changing time having one third or more of the resonance period of a liquid chamber is applied in a single print cycle, the meniscus is slowly drawn in inside the nozzle. Therefore, even the remnant of the ink, which has wet-spread far away from the nozzle hole and cannot be drawn-in by an inflation waveform element for a short time, can be drawn-in into the meniscus in such a long drawing-in time. Therefore, the overflown ink is almost all retrieved and the impact on discharging due to the overflown ink is substantially canceled. As a result, images having high quality can be obtained.

Static surface tension is a factor in the process of each ink permeating into a recording medium in the ink set mentioned above. Therefore, if a color image is formed by multiple kinds of inks having different colors and the difference in static surface tension of these values is different between each color, permeation state is different at the site where the inks having different colors contact, which leads to the degradation of the image quality.

In particular, since black color is easily visible, contours of fine lines and dots of black are clearly visible. Therefore, disturbance of an image tends to stand out. For example, if a dot of black ink having a high permeability, i.e., a low static surface tension is adjacent to a dot of another color ink having a low permeability, i.e., a high static surface tension, the black ink is drawn toward the color ink having a high static surface tension. For this reason, the black ink enters into the color ink, which makes the contour site unclear, which is referred to as bleed. This phenomenon tends to occur on a recording medium having a low permeability in particular, and also, this occurs at high performance printing due to a less permeation time.

To prevent this phenomenon, it is good to increase the static surface tension of the black ink and decrease the static surface tension of the other color ink. However, if the difference is excessively large, the other color ink enters into the black ink, making the text in black look thinner and causing bleed at the boundary site. Consequently, the image quality deteriorates.

If the static surface tension difference is small, bleed never or little occurs and the image quality is not substantially affected by contamination into the black ink having a low lightness. Therefore, in the present disclosure, the static surface tension of black ink is set to be equal to or at most 4 mN/m higher than the static surface tension of another color ink at 25 degrees C. so as to avoid this bleed issue.

According to the inkjet recording method of the present disclosure using the ink set mentioned above, even if the repellent film of a nozzle plate having nozzles constituting a liquid droplet discharging head is gradually degraded due to the physical burden accompanying the maintenance operation to keep the surface of the nozzle plate clean, the liquid droplet discharging head is capable of stably continuing discharging the ink set containing black ink and at least one color ink with discharging stability (no streak on a solid portion, no dot missing, no deviation of discharging). In addition, the quality of an obtained image is good (uniformity at solid print site, no bleed between black ink and color ink).

Each ink of the ink set contains water, a water-soluble organic solvent, a colorant, and a surfactant. It may contain other optional components.

The water, the water-soluble organic solvent, the colorant, the surfactant, and the other optional component in each ink of the ink set can be the same as those for the ink described above.

As describe above, as the ink for use in the inkjet recording method, an ink set including black ink and at least one color ink is used.

It is preferable that each ink of the ink set have a static surface tension of from 18.0 to 27.0 mN/m at 25 degrees C. and the difference obtained by subtracting the static surface tension of any of the other color ink from the static surface tension of the black color ink be from 0 to 4 mN/m. If the static surface tension is too high, the ink slowly permeates into a medium, which causes beading or strike-through. To the contrary, if the static surface tension is too low, the ink permeates too soon to prevent strike-through.

To satisfy these conditions, the addition amount of each component can be adjusted. For example, to decrease the static surface tension, the following methods are suitable.
Increase the addition amount of a surfactant and a permeating agent.
Use a surfactant having a strong power to reduce surface tension instead.
Decrease repellency of the repellent film on a nozzle plate.

Ink Container

The ink container for use in the present disclosure accommodates the ink or each ink of the ink set for use in the inkjet recording method of the present disclosure. Namely, the ink container is an article accommodating each ink therein and may optionally include other members.

There is no specific limitation to the container. Any form, any structure, any size, and any material can be suitably selected to suit to a particular application. For example, the container includes a plastic container or an ink accommodating unit formed of aluminum laminate film, etc.

Specific example thereof are illustrated in FIGS. 21 and 22. FIG. 21 is a diagram illustrating an example of the ink container. FIG. 22 is a diagram illustrating the ink container illustrated in FIG. 21 including the housing thereof.

An ink containing unit 241 is filled with the ink through an ink inlet 242. The air remaining in the ink containing unit 241 is discharged and thereafter the ink inlet 242 is closed by fusion. When in use, an ink outlet 243 made of rubber is pierced by the needle installed onto an inkjet recording device to supply the ink into the device. The ink accommodating unit 241 is made of a packaging material such as aluminum laminate film having no air permeability. As illustrated in FIG. 22, the ink containing unit 241 is typically housed in a housing 244 made of plastic and detachably attachable to a various inkjet recording devices as an ink container 240.

This ink container accommodates the ink or each ink of the ink set and can be used by detachably attaching to various inkjet recording devices and in particular preferably the inkjet recording device described later.

Next, the inkjet recording method of the present disclosure and the inkjet recording device are described with reference to drawings.

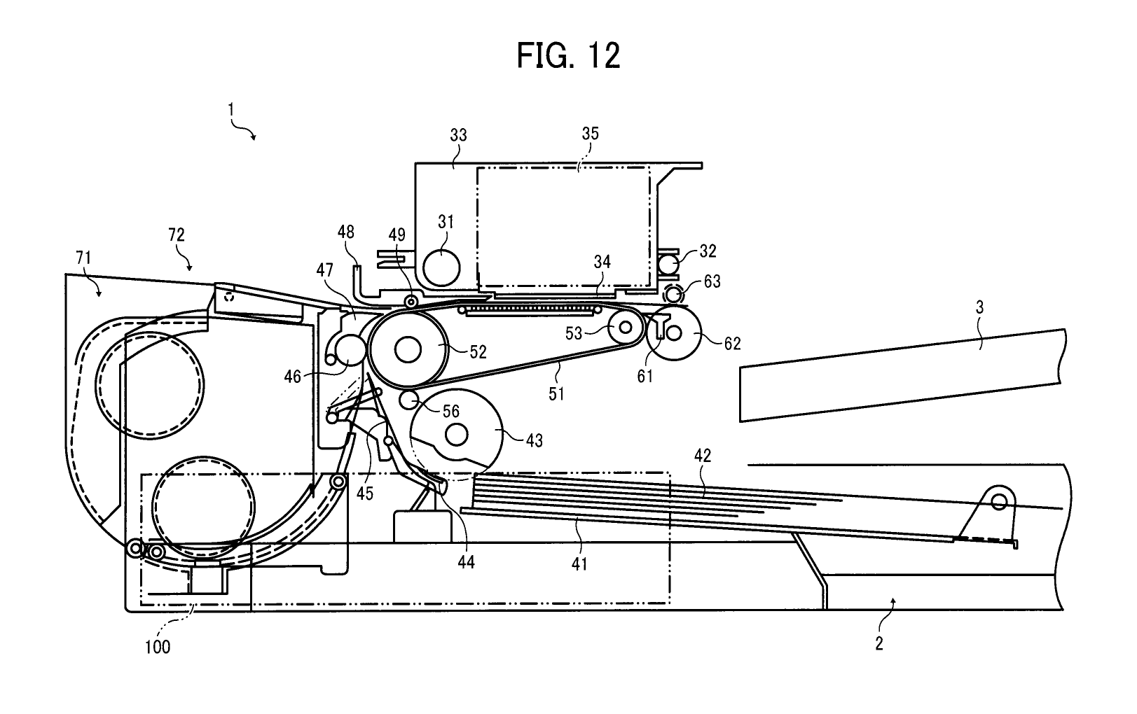

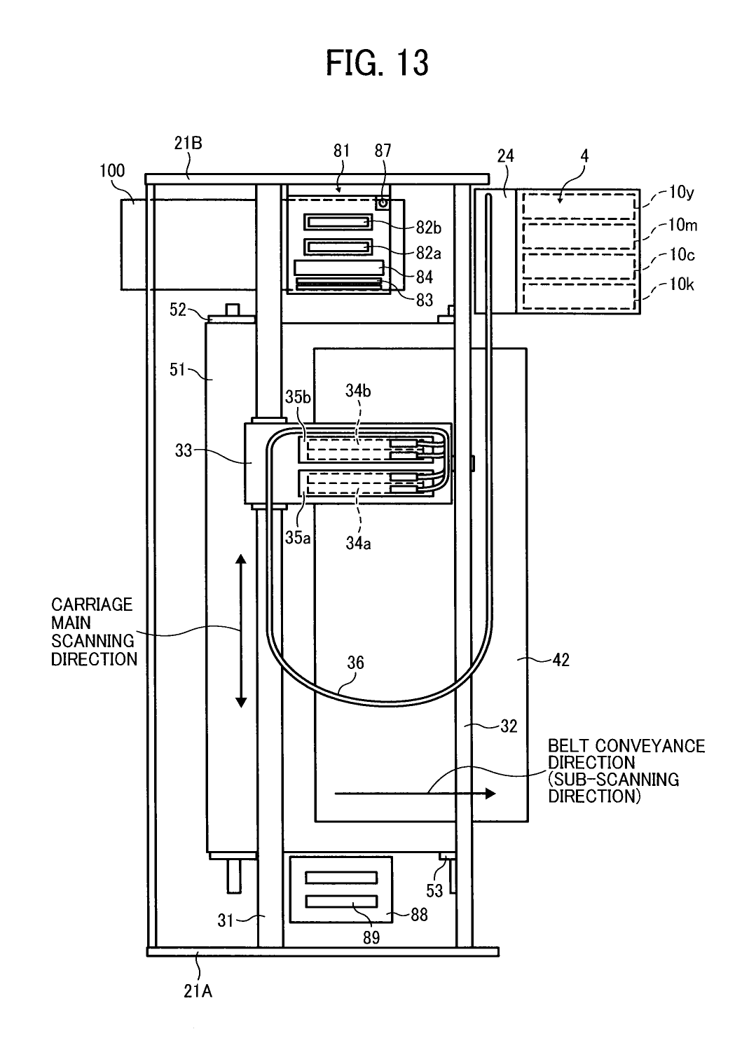

An embodiment of the inkjet recording device of the present disclosure is described with reference to FIGS. 12 and 13. FIG. 12 is a side view of an inkjet recording device illustrating the entire configuration thereof and FIG. 13 is a planar view thereof. This inkjet recording device is a serial type. In the device, a carriage 33 is slidably supported in the main scanning direction by main and sub guide rods 31 and 32 serving as a guide member laterally bridged between left and right side plates 21A and 21B. The inkjet recording device moves and scans in the direction indicated by the arrow in FIG. 13 by a main scanning motor via a timing belt.

The carriage 33 carries a recording head 34a and 34b (recording head 34 if not distinguished from each other) having droplet discharging heads to discharge ink droplets of each color of yellow (Y), cyan (C), magenta (M), and black (Bk). In addition, nozzle lines of multiple nozzles therein are arranged in the sub-scanning direction crossing vertically with the main scanning direction with the ink droplet discharging direction downward.

The recording head 34 each includes two nozzle lines. One of the nozzle lines of the recording head 34a discharges droplets of black (K) and the other discharges droplets of cyan (C). One of the nozzle lines of the recording head 34b discharges droplets of magenta (M) and the other discharges droplets of yellow (Y). It is also possible to use a recording head including nozzle lines of each color having multiple nozzles on the surface of a single nozzle plate as the recording head 34.

The carriage 33 carries sub-tanks 35a and 35b (sub-tank 35 if not distinguished) serving as a second ink supplying unit to supply each color ink corresponding to the nozzle line of the recording head 34. The recording liquid of each color is replenished and supplied to this sub-tank 35 from ink containers (main tank) 10y, 10m, 10c, and 10k detachably attached to an ink container installation unit 4 by a supply pump unit 24 via a supply tube 36 for each color.

A sheet feeding unit to feed a sheet 42 loaded on a sheet loader (pressure plate) 41 of a sheet feeder tray 2 includes a half-moon shape roller (sheet feeding roller) 43 to separate and feed the sheet 42 one by one from the sheet loader 41 and a separation pad 44 made of a material having a large friction index and arranged facing the sheet feeding roller 43 while being biased towards the sheet feeding roller 43.

To feed the sheet 42 fed from the sheet feeding unit below the recording head 34, there are provided a guide member 45 to guide the sheet 42, a counter roller 46, a transfer guide member 47, a pressing member 48 having a front pressing roller 49, and a transfer belt 51 serving as a transfer device to electrostatically adsorb the sheet 42 and transfer the sheet 42 at a position facing the recording head 34.

The transfer belt 51 is an endless form belt, stretched between a transfer roller 52 and a tension roller 53 and configured rotatable in the belt transfer direction (sub-scanning direction).

In addition, a charging roller 56 serving as a charger is disposed to charge the surface of the transfer belt 51. This charging roller 56 is disposed to be in contact with the top layer of the transfer belt 51 in order to be rotationarily driven to the rotation of the transfer belt 51. The transfer belt 51 circularly moves in the belt transfer direction (sub-scanning direction) illustrated in FIG. 13 by the transfer roller 52 rotationarily driven by a sub-scanning motor via a timing belt.

Furthermore, as the sheet ejection unit to eject the sheet 42 having an image thereon recorded by the recording head 34, there are provided a separation claw 61 to separate the sheet 42 from the transfer belt 51, an ejection roller 62, and a spur 63 serving as another ejection roller. Also, an ejection tray 3 is disposed below the discharging roller 62.

A double-face print unit 71 is installed onto the rear side of an inkjet recording device 1 in a detachable manner. The double-face print unit 71 takes in and reverses the sheet 42 returned by the reverse rotation of the transfer belt 51 and feeds it again between the counter roller 46 and the transfer belt 51. In addition, the upper surface of the double-face unit 71 serves as a bypass tray 72.

Furthermore, a maintenance and recovery mechanism 81 is arranged in the non-image forming area on one side of the carriage 33 in the scanning direction thereof and maintains and recovers the state of the nozzle of the recording head 34. The maintenance and recovery mechanism 81 includes each capping member (hereinafter referred to as cap), i.e., 82a and 82b (simply 82 when not distinguished from each other), a wiping member (wiper blade) 83 to wipe off the surface of nozzle plate, and a dummy discharging receiver 84 to receive droplets discharged not for recording but for dummy discharging to eject thickened recording liquid, and a carriage lock 87 to lock the carriage 33. In addition, below the maintenance and recovery mechanism 81, a waste liquid tank 100 is exchangeably attached to the inkjet recording device 1 to accommodate waste liquid collected during the maintenance and recovery operation.

In addition, in the non-image forming areas on the other side of the carriage 33 in the scanning direction, a dummy discharging receiver 88 is disposed to receive droplets discharged not for recording but for dummy discharging to remove the recording liquid thickened during recording, etc. The dummy discharging receiver 88 includes slits 89 along the direction of the nozzle line of the recording head 34.

In the inkjet recording device configured in the manner described above, the sheet 42 is separated and fed from the sheet feeder tray 2 one by one substantially vertically upward, guided by the guide 45, and transferred while being pinched between the transfer belt 51 and the counter roller 46. Moreover, the front of the sheet 42 is guided by the transfer guide 47 and pressed to the transfer belt 51 by the front pressing roller 49 to change the transfer direction substantially 90 degrees C.

During this operation, positive and negative voltages are alternately applied to the charging roller 56 to charge the transfer belt 51 in an alternate charging voltage pattern. When the sheet 42 is fed onto the transfer belt 51 charged with this alternate pattern, the sheet 42 is adsorbed to the transfer belt 51 and transferred thereon in the sub-scanning direction by the circulation movement of the transfer belt 51.

By driving the recording head 34 in response to the image signal while moving the carriage 33, ink droplets are discharged to the sheet 42 standing still to record an image for an amount corresponding to one line and thereafter the sheet 42 is transferred in a predetermined amount for recording in the next line. On receiving a signal indicating that the recording completes or the rear end of the sheet 42 has reached the image recording area, the recording operation stops and the sheet 42 is ejected to the ejection tray 3.

When maintaining and recovering the nozzle of the recording head 34, the carriage 33 is moved to the home position facing the maintenance and recovery mechanism 81, the maintenance and recovery operation is conducted by capping by the capping member 82 for nozzle suction and dummy discharging to discharge liquid droplets not contributing to image forming. For this reason, liquid droplets are stably discharged to form images.

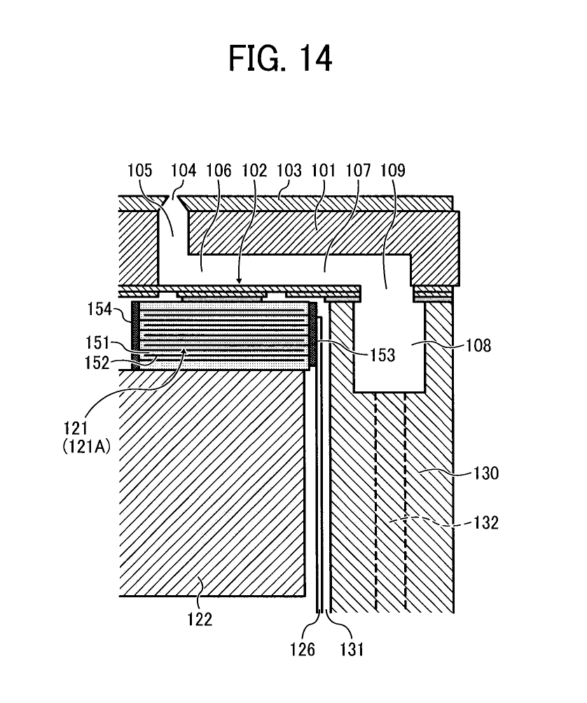

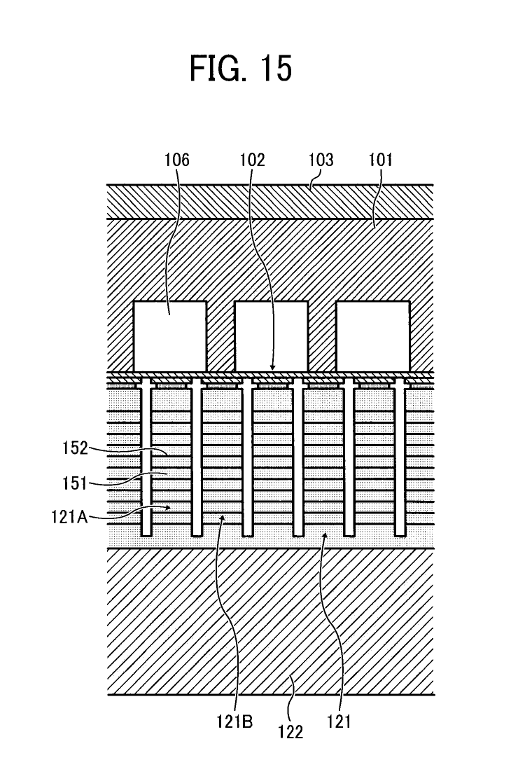

Next, an embodiment of the liquid discharging head constituting the recording head 34 is described with reference to FIGS. 14 and 15. FIG. 14 is a cross section along the longitudinal direction of the liquid chamber of the recording head 34 and FIG. 15 is a cross section along the traverse direction (direction of nozzle alignment) of the liquid chamber of the recording head 34.

In this liquid discharging head, a vibration plate 102 is attached to the bottom surface of a flow path plate 101 and a nozzle plate 103 is attached to the top surface of the flow path plate 101. These form a nozzle communicating path 105 serving as a flow path communicating with a nozzle 104 discharging liquid droplet (ink droplet), a liquid chamber 106 serving as a pressure generating chamber, and an ink supplying hole 109 communicating with a common liquid chamber 108 to supply ink to the liquid chamber 106 through a fluid resistance portion (supply path) 107.

In addition, the liquid discharging head includes two laminating type piezoelectric members (electromechanical transduction element) 121 serving as a pressure generating device (actuator) transforming the vibration plate 102 to apply pressure to ink in the liquid chamber and a base substrate 122 where the piezoelectric member 121 is attached and fixed. Only one of the piezoelectric members 121 is illustrated in FIG. 14. This piezoelectric element 121 includes multiple piezoelectric element pillars 121A and 121B by forming slits by non-separating slit processing. In this embodiment, the piezoelectric element pillar 121A is a drive piezoelectric element pillar applying a drive waveform and the piezoelectric element pillar 121B is a non-drive piezoelectric element pillar not applying a drive waveform. In addition, an FPC cable 126 including a drive circuit (drive IC) is connected to the drive piezoelectric element pillar 121A of the piezoelectric member 121.

The peripheral site of the vibration plate 102 is attached to a frame member 130. A piecing unit 131 accommodating an actuator unit configured by the piezoelectric member 121, the base substrate 122, etc, a concave portion forming the common liquid chamber 108, and an ink supply hole 132 serving as a liquid supply hole to supply ink to the common liquid chamber 108 from outside are formed in the frame member 130.

On the flow path plate 101, for example, the concave portion and hole portion are formed as the nozzle communicating path 105 and the liquid chamber 106 by anisotropic etching a single crystal silicon substrate having crystal plane orientation (110) using alkali etching liquid such as potassium hydroxide (KOH) aqueous liquid. However, the flow path plate 101 is not limited to the single crystal silicon substrate but other stainless substrates and photoconductive resins can be used.

The vibration plate 102 is formed out of nickel metal plate. For example, an electroforming method is utilized. Also, metal plates and joint members of metal and resin plates may be used. The piezoelectric element pillars 121A and 121B of the piezoelectric element 121 are glued to the vibration plate 102 and the frame member 130 is glued thereto.

On the nozzle plate 103, the nozzle 104 having a diameter of from 10 to 30 μm is formed corresponding to each liquid chamber 106. The nozzle plate 103 is glued to the flow path plate 101 with an adhesive. It is preferable that a repellent film be formed on the uppermost surface on the ink discharging side of the surface of the nozzle forming member made of metal members via a predetermined layer.

The piezoelectric member 121 is a lamination type piezoelectric element (PZT in this case) in which a piezoelectric material 151 and an inside electrodes 152 are alternately laminated. Each inside electrode 152 alternately pulled out to different end surfaces of the piezoelectric member 121 is connected to an individual electrode 153 and a common electrode 154. In this embodiment, it is possible to have a configuration in which the ink in the liquid chamber 106 is pressurized using the displacement along a d33 direction as the piezoelectric direction of the piezoelectric member 121 or another configuration in which the ink in the liquid chamber 106 can be pressurized using the displacement along a d31 direction as the piezoelectric direction of the piezoelectric member 121.

In the liquid discharging head configured as described above, for example, when the voltage applied to the piezoelectric member 121 is lowered from a reference voltage Ve, the drive piezoelectric element pillar 121A is contracted and the vibration plate 102 is lowered, thereby inflating the volume of the liquid chamber 106. As a result, the ink flows into the liquid chamber 106 and thereafter the voltage applied to the piezoelectric element pillar 121A is increased to elongate the piezoelectric element pillar 121A in the lamination direction. Accordingly, the vibration plate 102 is transformed along the direction of the nozzle 104 to contract the volume of the liquid chamber 106. As a result, the ink in the liquid chamber 106 is pressurized so that ink droplets are discharged (jetted) from the nozzle 104. Thereafter, the voltage applied to the piezoelectric element 12A is returned to the reference voltage Ve. Accordingly, the vibration plate 102 is back to the initial position so that the liquid chamber 106 inflates, which generates a negative pressure. At this point in time, the ink is supplied from the common liquid chamber 108 to the liquid chamber 106. After the vibration of the meniscus surface of the nozzle 104 decays and is stabilized, the system starts behaviors to discharge next droplets.

The drive method of the head is not limited to the above-mentioned (pull-push discharging). The way of discharging changes depending on how a drive waveform is imparted (for example, pull discharging or push discharging).

In inkjet recording, the form and manufacturing accuracy of a nozzle and the surface property of a nozzle plate are known to have a large impact on the dischargeability of ink droplets. If ink is attached around a nozzle on the surface of a nozzle plate, the discharging direction of ink droplets is deviated or jetting speed may be unstable. To prevent such problems caused by ink attachment, a repellent film is formed on the surface of the nozzle plate to impart repellency to stabilize discharging stability of ink droplets. However, when removing ink attached to the repellent film during maintenance such as suction, the repellent film is gradually peeled off, which degrades repellency of the nozzle plate. In an attempt to solve this problem, attachability between the repellent film and the nozzle plate is improved. However, it is not easy to prevent the degradation of the repellent film.

The recording head for use in the present disclosure has a nozzle plate having nozzles and the nozzle plate preferably includes a repellent film disposed on the surface on the ink discharging side. It is suitable to provide an under layer of an inorganic oxide as an under layer of the repellent film before forming the repellent film on the surface of the nozzle plate.

The repellent film can be any known repellent film and preferably contains a polymer having a perfluoroalkyl chain. Preferably, the repellent film is formed in the following manner.

(1) Solgel method: A repellency treatment agent solution prepared by dissolving in a solvent either (A) of both of a polymer and an oligomer including at least one perfluoroalkyl group and at least one alkoxysilyl group and a silane compound (B) represented by the following chemical formula II is applied to the surface of the nozzle plate mentioned above on the ink discharging side and thereafter reaction is conducted to form a repellent film, which is thereafter fixated.

Si(Y)(OR)₃ Chemical formula II

In the chemical formula II, R represents a hydrogen atom or an alkyl group, Y represents an alkyl group that may have a substitution group, an aryl group that may have a substitution group, or an OR group in the chemical formula II. Individual Rs each, can independently be the same or different.

(2) Vapor deposition method: a SiO₂ film is formed on the surface on the ink discharging side and at least either (A) of a polymer or an oligomer including at least one perfluoroalkyl group and at least one alkoxysilyl group and a silane compound (B) represented by the following chemical formula II are repeatedly deposited on the SiO₂ film as the vapor deposition sources in different zones in a vacuum tank to react the deposited (A) and the deposited (B) to form a repellent film, which is thereafter fixated.

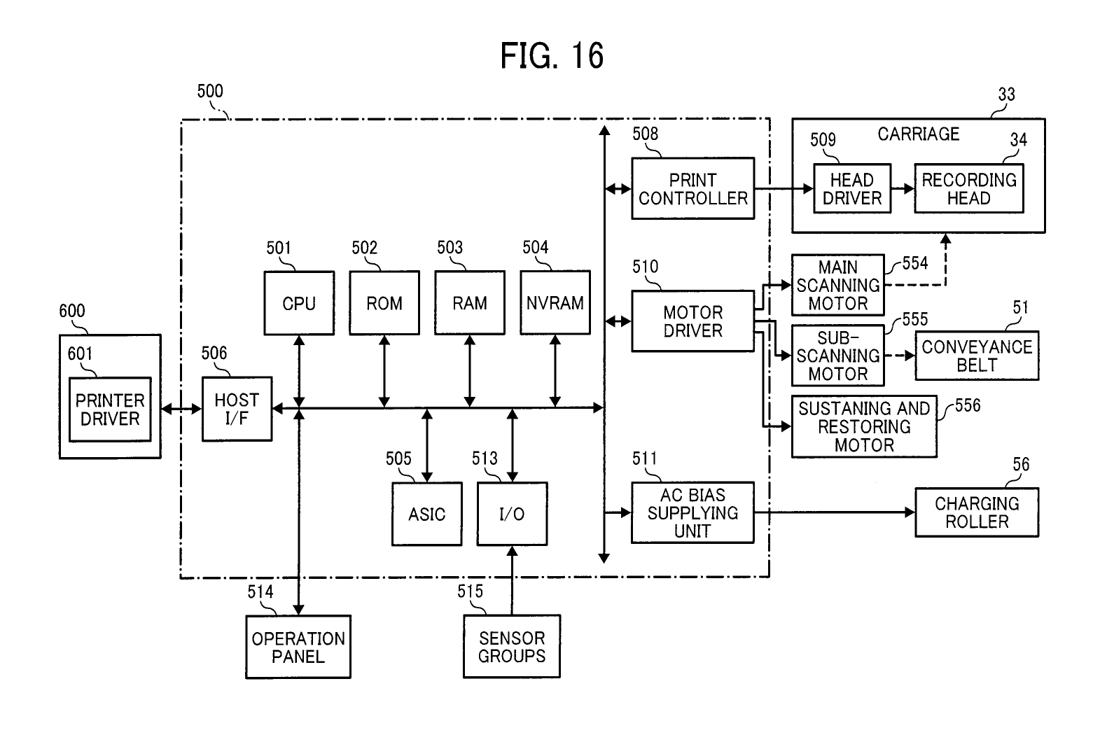

Next, the control unit of the inkjet recording device is described with reference to FIG. 16. FIG. 16 is a block diagram illustrating the control unit.

This control unit 500 includes a central processing unit (CPU) 501 controlling the entire device, programs executed by the CPU 501, a read-only memory (ROM) 502 to store other fixed data, a random access memory (RAM) 503 to temporarily store image data, etc., a rewritable non-volatile random access memory (NVRAM) 504 on which data are held even while the power supply is cut, and an application specific integrated circuit (ASIC) 505 to conduct various signal processing for image data and image processing for sorting, etc., and process input and output signals to control the entire device.

In addition, the control unit 500 also includes a data transfer device to drive and control the recording head 34, a print control unit 508 including a signal generating device, a head driver (driver IC) 509 to drive the recording head 34 disposed on the side of the carriage 33, a main scanning motor 554 to move and scan the carriage 33, a sub-scanning motor 555 to circulatorily move the transfer belt 51, a motor control unit 510 to drive a maintenance and recovery motor 556 for moving the cap 82 and the wiping member 83 of the maintenance and recovery mechanism 81, and an AC bias supplying unit 511 to supply an AC bias to the charging roller 56.

In addition, this control unit 500 is connected to an operation panel 514 to input and display information for the device.

The control unit 500 includes an I/F 506 to send and receive data and signals with a host computer and receives such data from a host 600 such as image processing device such as a home computer, an image reader such as an image scanner, and an imaging device such as a digital camera at the I/F 506 via a cable or a network.

The CPU 501 of the control unit 500 reads and analyzes print data in the reception buffer included in the I/F 506, conducts image processing and data sorting at an ASIC 505, and transfers the image data from the print control unit 508 to the head driver 509.

The dot pattern data to output images are created at a printer driver 601 on a host 600.

In addition to transfer of serial data of the image data described above, the print control unit 508 outputs transfer clocks, latch signals, control signals, etc. required to transfer the image data and determine the transfer. Moreover, the print control unit 508 includes a drive signal generating unit configured by a D/A converter to digital-analogue convert the pattern data of a drive pulse stored in the ROM, a voltage amplifier, a current amplifier, etc. and outputs a particular signal for use in the present disclosure to the head driver 509.

The head driver 509 selects a drive pulse constituting a drive waveform provided from the print control unit 508 based on the serially input image data corresponding to an amount of a single line of the recording head 34 to generate a draw-in pulse and a discharging pulse and applies the pulses to a piezoelectric element serving as a pressure generating device generating an energy to discharge droplets of the recording head 34, thereby driving the recording head 34. At this point, part or the entire of the drive pulse constituting the drive waveform and part or the entire of the element for waveform forming the drive pulse are selected to discharge droplets having different sizes, for example, large droplets, middle-sized droplets, small droplets so that dots having different size can be formed.

An I/O unit 513 acquires information from various sensors 515 installed onto the device, extracts the information to control a printer, and use it to control the printer control unit 508, the motor control unit 510, and the AC bias supplying unit 511. The sensors 515 includes an optical sensor to detect the position of a sheet, a thermistor to monitor the temperature in the device, a sensor to monitor the voltage of the charging belt, and an interlock switch to detect open and close of a cover. The I/O unit 513 is capable of processing various kinds of sensor information.

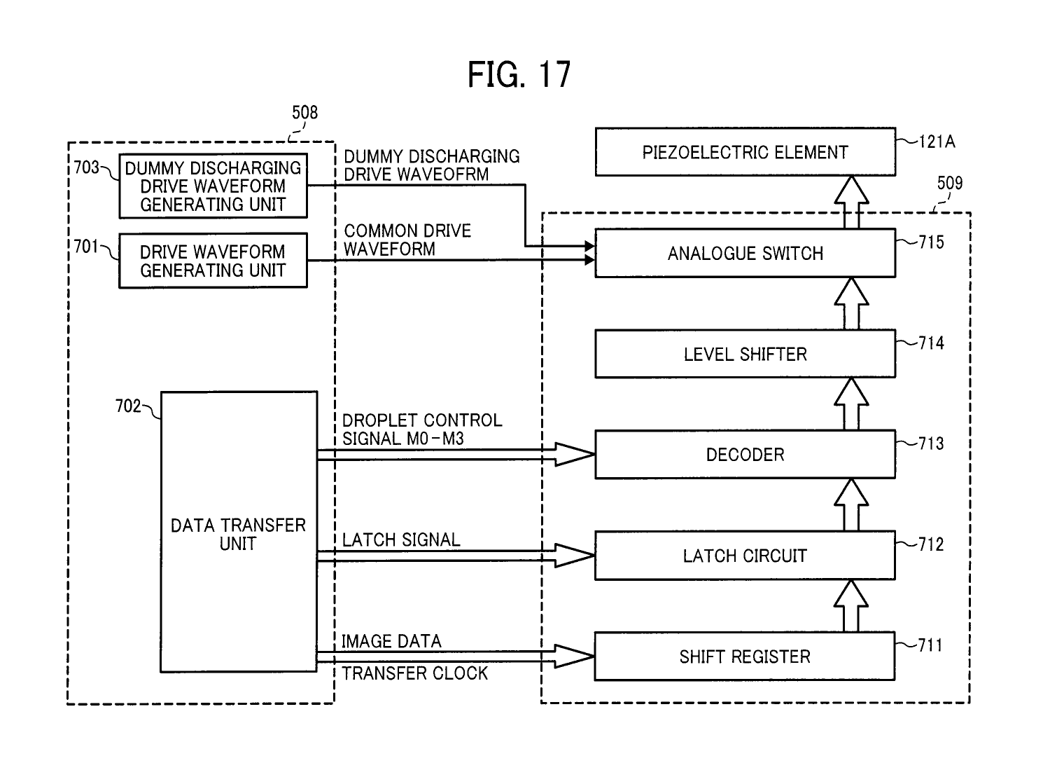

Next, an embodiment of the print control unit 508 and the head driver 509 are described with reference to FIG. 17.

The print control unit 508 includes a drive waveform generating unit 701 to generate and output a drive waveform having a drive pulse having a voltage changing time of inflating waveform element (voltage changing part to draw in ink in a nozzle) in a single print cycle during image forming of 1/3 or more of the resonance period of the liquid chamber, a data transfer unit 702 to output 2-bit image data (gradation signals 0 and 1) corresponding to print image, clock signals, latch signals (LAT), and droplet control signals M0 to M3, and a dummy discharging drive waveform generating unit 703 to generate and output a drive waveform for dummy discharging.

The droplet control signal is a 2-bit signal to provide an instruction for every droplet on open and close of an analogue switch 715 serving as a switching device of the head driver 509 and transitions to H level (ON) by a drive pulse or a drive waveform selected to the print cycle of the common drive waveform and to L level (OFF) when not selected.

The head driver 509 includes a shift resistor 711 to input a transfer clock (shift clock) from the data transfer unit 702 and a serial image data (gradation data: 2 bit/1 channel, per nozzle), a latch circuit 712 to latch each resist value of the shift resistor 711 by a latch signal, a decoder 713 to decode the gradation data and the control signals M0 to M3 to output the result, a level shifter 714 to change a logic level voltage signal of the decoder 713 to a level where the analogue switch is operable, and the analogue switch 715 made open and close by the output of the decoder 713 provided via the level shifter 714.

Ink Recorded Matter

An image is formed on a recording medium utilizing the inkjet recording method of the present disclosure to obtain ink printed matter.

There is no specific limitation to the recording medium and it can be suitably selected to suit to a particular application. For example, plain paper, gloss paper, special paper, cloth, film, transparent sheets, print sheet for general purpose, etc. are suitable. These can be used alone or in combination.

The ink recorded matter can be suitably used for various purposes as references, etc., on which various images, etc. are recorded.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### Examples

Next, the present disclosure is described in detail with reference to Examples but is not limited thereto.

Manufacturing Example 1 of Pigment Dispersion

Manufacturing of Cyan Dispersion

After sufficient replacement with nitrogen gas in a flask equipped with a mechanical stirrer, a thermometer, a nitrogen gas introducing tube, a reflux tube, and a dripping funnel, 11.2 g of styrene, 2.8 g of acrylic acid, 12.0 g of lauryl methacrylate, 4.0 g of polyethlene glycol methacrylate, 4.0 g of styrene macromer (AS-6, manufactured by TOA GOSEI CO., LTD.), and 0.4 g of mercapto ethanol were charged in the flask and the system was heated to 65 degrees C. Next, a liquid mixture of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer (AS-6, manufactured by TOA GOSEI CO., LTD.), 3.6 g of mercapto ethanol, 2.4 g of azobisdimethyl valeronitrile, and 18 g of methylethyl ketone was dripped into the flask in two and a half hours.

Subsequently, a liquid mixture of 0.8 g of azobisdimethyl valeronitrile and 18 g of methylethyl ketone was dripped into the flask in half an hour. Subsequent to one-hour aging at 65 degrees C., 0.8 parts of azobisdimethyl valeronitrile was added followed by furthermore one-hour aging. After completion of the reaction, 364 g of methylethyl ketone was added to the flask to obtain 800 g of polymer solution having a concentration of 50 percent by mass. Next, part of the polymer solution was dried. The weight average molecular weight was 15,000 as measured by gel permeation chromatography (standard: polystyrene, solvent: tetrahydrofuran).

28 g of the polymer solution, 26 g of pigment blue 15:3 (CHROMOFINE BLUE A-220JC, manufactured by Dainichiseika Color & Chemicals Mfg. Co., Ltd.), 13.6 g of 1 mol/l potassium hydroxide solution, 20 g of methylethyl ketone, and 30 g of deionized water were sufficiently stirred.

Thereafter, the resultant was mixed and kneaded 20 times by a three-roll mill (Product name: NR-84A, manufactured by NORITAKE CO., LIMITED). The thus-obtained paste was charged in 200 g of deionized water. Subsequent to sufficient stirring, methylethyl ketone and water were distilled away using an evaporator to obtain 160 g of a blue polymer particulate dispersion having a solid portion of 20.0 percent by mass.

The average particle diameter (D50) of the thus-obtained polymer particulate was 98 nm as measured by MICROTRAC UPA (manufactured by NIKKISO CO., LTD.).

Manufacturing Example 2 of Pigment Dispersion

Manufacturing of Magenta Dispersion

A red violet polymer particulate dispersion was obtained in the same manner as in the Manufacturing Example 1 of the pigment dispersion except that pigment blue 15:3 (copper phthalocyanine pigment) was changed to pigment red 122 (CHROMOFINE MAGENTA 6886, manufactured by Dainichiseika Color & Chemicals Mfg. Co., Ltd.).

The average particle diameter (D50) of the thus-obtained polymer particulate was 124 nm as measured by MICROTRAC UPA (manufactured by NIKKISO CO., LTD.).

Manufacturing Example 3 of Pigment Dispersion

Manufacturing of Yellow Dispersion

A yellow polymer particulate dispersion was obtained in the same manner as in the Manufacturing Example 1 of the pigment dispersion except that pigment blue 15:3 (copper phthalocyanine pigment) was changed to pigment yellow 74 (FAST YELLOW 531, manufactured by Dainichiseika Color & Chemicals Mfg. Co., Ltd.).

The average particle diameter (D50) of the thus-obtained polymer particulate was 78 nm as measured by MICROTRAC UPA (manufactured by NIKKISO CO., LTD.).

Manufacturing Example 4 of Pigment Dispersion

Manufacturing of Black Dispersion

A black polymer particulate dispersion was obtained in the same manner as in the Manufacturing Example 1 of the pigment dispersion except that pigment blue 15:3 (copper phthalocyanine pigment) was changed to carbon black (FW100, manufactured by Degussa AG).

The average particle diameter (D50) of the thus-obtained polymer particulate was 110 nm as measured by MICROTRAC UPA (manufactured by NIKKISO CO., LTD.).

Ink Preparation Examples 1 to 20

Each ink of Ink Preparation Examples 1 to 20 was manufactured by an ordinary method following the prescription shown in Tables 1 to 3 using each pigment dispersion manufactured in the Manufacturing Examples 1 to 4 of the pigment dispersion and adjusted to be pH 9 by 10 percent aqueous solution of sodium hydroxide.

Specifically, a water-soluble organic solvent, a surfactant, a fungicide, a foam inhibitor, a defoaming agent, a permeating agent, and deionized water were prescribed in this sequence and stirred for 30 minutes. Thereafter, the pigment dispersions obtained in the Manufacturing Examples 1 to 4 of the pigment dispersion were added. Subsequent to stirring for 30 minutes, the resultant was filtrated by a membrane filter having a hole diameter of 0.8 μm to obtain each ink of Ink Preparation Examples 1 to 20. The unit of the values in Tables 1 to 3 is percent by mass.

TABLE 1

| | | Preparation examples of ink | | | | | |
|---|---|---|---|---|---|---|---|
| | | 1 | 2 | 3 | 4 | 5 | 6 |
| Manufacturing | C | 35.0 | | | | 30.0 | |
| Example 1 of | | | | | | | |
| dispersion | | | | | | | |
| Manufacturing | M | | 40.0 | | | | 35.0 |
| Example 2 of | | | | | | | |
| dispersion | | | | | | | |
| Manufacturing | Y | | | 35.0 | | | |
| Example 3 of | | | | | | | |
| dispersion | | | | | | | |
| Manufacturing | K | | | | 40.0 | | |
| Example 4 of | | | | | | | |
| dispersion | | | | | | | |
| Surfactant | Surfactant A | 0.05 | 0.05 | 0.05 | 0.05 | 0.03 | 0.03 |
| | Surfactant B | | | | | | |
| | Surfactant C | | | | | | |
| | Surfactant D | | | | | | |
| Water-soluble | Glycerin | | | | | 5.0 | 5.0 |
| organic solvent | 3-methyl-1,3- | 5.0 | | | | | |
| | butane diol | | | | | | |
| | 1,3-butane diol | | | 7.0 | 10.0 | | |
| | 1,2-butane diol | | | | | | 10.0 |
| | 1,2-propanediol | 30.0 | 40.0 | 35.0 | 25.0 | | |
| | 1,6-hexane diol | | | | | | |
| | 1,5-pentane diol | | | | | 30.0 | 20.0 |
| | 2-pyrroridone | | | | | | |
| Foam | 2,4,7,9- | 0.25 | 0.25 | 0.25 | 0.25 | 0.25 | 0.25 |
| inhibitor | tetramethyldecane- | | | | | | |
| | 4,7-diol | | | | | | |
| Defoaming | KM-72F | | | | | | |
| agent | | | | | | | |
| Permeating | 2-ethyl-1,3- | 3.0 | 3.0 | 3.0 | 3.0 | 3.0 | 3.0 |
| agent | hexanediol | | | | | | |
| Fungicides | PROXEL LV | 0.20 | 0.20 | 0.20 | 0.20 | 0.20 | 0.20 |
| pH | 10 percent | Proper | Proper | Proper | Proper | Proper | Proper |
| regulator | aqueous solution | quantity | quantity | quantity | quantity | quantity | quantity |
| | of sodium | | | | | | |
| | hydroxide | | | | | | |
| Deionized | | Rest | Rest | Rest | Rest | Rest | Rest |
| water | | | | | | | |
| Total | | 100.0 | 100.0 | 100.0 | 100.0 | 100.0 | 100.0 |

TABLE 2

| | | Preparation examples of ink | | | | | |
|---|---|---|---|---|---|---|---|
| | | 7 | 8 | 9 | 10 | 11 | 12 |
| Manufacturing | C | | | 15.0 | | | |
| Example 1 of | | | | | | | |
| dispersion | | | | | | | |
| Manufacturing | M | | | | 20.0 | | |
| Example 2 of | | | | | | | |
| dispersion | | | | | | | |
| Manufacturing | Y | 20.0 | | | | 20.0 | |
| Example 3 of | | | | | | | |
| dispersion | | | | | | | |
| Manufacturing | K | | 25.0 | | | | 25.0 |
| Example 4 of | | | | | | | |
| dispersion | | | | | | | |
| Surfactant | Surfactant A | 0.02 | 0.02 | | | | |
| | Surfactant B | | | 6.0 | 6.0 | | |
| | Surfactant C | | | | | 0.50 | 0.50 |
| | Surfactant D | | | | | | |
| Water-soluble | Glycerin | 10.0 | 10.0 | 30.0 | 20.0 | 5.0 | 5.0 |
| organic solvent | 3-methyl-1,3- | | | 15.0 | | | |
| | butane diol | | | | | | |
| | 1,3-butane diol | | | | | 25.0 | 25.0 |
| | 1,2-butane diol | 28.0 | | | | | |
| | 1,2-propanediol | | 30.0 | | | | |
| | 1,6-hexane diol | | | | | | |
| | 1,5-pentane diol | | | | 10.0 | | |
| | 2-pyrroridone | | | | | 2.0 | 2.0 |
| Foam | 2,4,7,9- | 0.15 | 0.15 | | | 0.20 | 0.20 |
| inhibitor | tetramethyldecane- | | | | | | |
| | 4,7-diol | | | | | | |
| Defoaming | KM-72F | | | 3.0 | 3.0 | | |
| agent | | | | | | | |
| Permeating | 2-ethyl-1,3- | 3.0 | 3.0 | 3.0 | 3.0 | 3.0 | 3.0 |
| agent | hexanediol | | | | | | |
| Fungicides | PROXEL LV | 0.20 | 0.20 | 0.20 | 0.20 | 0.20 | 0.20 |
| pH | 10 percent | Proper | Proper | Proper | Proper | Proper | Proper |
| regulator | aqueous solution | quantity | quantity | quantity | quantity | quantity | quantity |
| | of sodium | | | | | | |
| | hydroxide | | | | | | |
| Deionized | | Rest | Rest | Rest | Rest | Rest | Rest |
| water | | | | | | | |
| Total | | 100.0 | 100.0 | 100.0 | 100.0 | 100.0 | 100.0 |

TABLE 3

| | | Preparation examples of ink | | | | | | | |
|---|---|---|---|---|---|---|---|---|---|
| | | 13 | 14 | 15 | 16 | 17 | 18 | 19 | 20 |
| Manufacturing | C | 20.0 | | | | 15.0 | | | |
| Example 1 of | | | | | | | | | |
| dispersion | | | | | | | | | |
| Manufacturing | M | | 25.0 | | | | 20.0 | | |
| Example 2 of | | | | | | | | | |
| dispersion | | | | | | | | | |
| Manufacturing | Y | | | 35.0 | | | | 35.0 | |
| Example 3 of | | | | | | | | | |
| dispersion | | | | | | | | | |
| Manufacturing | K | | | | 40.0 | | | | 40.0 |
| Example 4 of | | | | | | | | | |
| dispersion | | | | | | | | | |
| Surfactant | Surfactant A | | | 0.005 | 0.005 | | | 0.15 | 0.15 |
| | Surfactant B | | | | | 0.5 | 0.5 | | |
| | Surfactant C | | | | | | | | |
| | Surfactant D | 2.2 | 2.2 | | | | | | |
| Water-soluble | Glycerin | 15.0 | 15.0 | | | 30.0 | 20.0 | | |
| organic solvent | 3-methyl-1,3- | | | | | 15.0 | | | |
| | butane diol | | | | | | | | |
| | 1,3-butane diol | | | 7.0 | 10.0 | | | 7.0 | 10.0 |
| | 1,2-butane diol | | | | | | | | |
| | 1,2-propanediol | | 20.0 | 35.0 | 25.0 | | | 35.0 | 25.0 |
| | 1,6-hexane diol | 18.0 | | | | | | | |
| | 1,5-pentane diol | | | | | | 10.0 | | |
| | 2-pyrroridone | | | | | | | | |
| Foam | 2,4,7,9- | | | 0.25 | 0.03 | | | 0.25 | 0.03 |
| inhibitor | tetramethyldecane- | | | | | | | | |
| | 4,7-diol | | | | | | | | |
| Defoaming | KM-72F | 0.50 | 0.50 | | | 0.2 | 0.2 | | |
| agent | | | | | | | | | |
| Permeating | 2-ethyl-1,3- | 2.0 | 2.0 | 3.0 | 3.0 | 3.0 | 3.0 | 3.0 | 3.0 |
| agent | hexanediol | | | | | | | | |
| Fungicides | PROXEL LV | 0.25 | 0.25 | 0.20 | 0.20 | 0.20 | 0.20 | 0.20 | 0.20 |
| pH | 10 percent | Proper | Proper | Proper | Proper | Proper | Proper | Proper | Proper |
| regulator | aqueous solution | quantity | quantity | quantity | quantity | quantity | quantity | quantity | quantity |
| | of sodium | | | | | | | | |
| | hydroxide | | | | | | | | |
| Deionized | | Rest | Rest | Rest | Rest | Rest | Rest | Rest | Rest |
| water | | | | | | | | | |
| Total | | 100.0 | 100.0 | 100.0 | 100.0 | 100.0 | 100.0 | 100.0 | 100.0 |

Abbreviated symbols in Tables 1 to 3 are as follows.
Surfactant A: Fluoro surfactant (UNIDYNE DSN-403N, mixture of addition reaction product of perfluoroalkyl polyethylene oxide and polyethylene glycol, manufactured by DAIKIN INDUSTRIES, ltd.)
Surfactant B: represented by the following Chemical formula I, where n=4, a=21, and b=12 (FS-300, manufactured by E. I. du Pont de Nemours and Company)

CₙF₂ₙ₊₁—CH₂CH(OH)CH₂—O—(CH₂CH₂O)ₐ—Y′ Chemical formula I

In the Chemical formula I, “Y′” represents —C_{b}H_{2b+1}.
Surfactant C: Polyether-modified silicone-based surfactant (component 100 percent by percent by weight, BYK-379, manufactured by BYK Japan KK.)
Surfactant D: Polyoxyethylene (3) tridecylether sodium acetate (ECTD-3NEX, manufactured by Nikko Chemicals Co., Ltd.)
KM-72F, self-emulsification type silicone defoaming agent (component: 100 percent by mass, manufactured by Shin-Etsu Silicone Co., Ltd.)
PROXEL LV, fungicide (manufactured by AVECIA GROUP)

Property of Ink

Viscosity and static surface tension were measured for each ink of the Ink Preparation Examples 1 to 20 as follows. The results are shown in Table 4.

When the static surface tension of each ink is in the range of from 18.0 to 27.0 mN/m, it is evaluated as A. When the static surface tension of each ink is outside the range of from 18.0 to 27.0 mN/m, it is evaluated as B. The results are also shown.

Viscosity

Viscosity (mPa·s) of each ink at 25 degrees C. was measured at appropriate rotation speed of from 10 to 100 rpm using an R type viscometer (RC-500, manufactured by TOKI SANGYO CO., LTD.).

Static Surface Tension

The static surface tension of each ink at 25 degrees C. was measured by a fully-automatic surface tensiometer (CBVP-Z, manufactured by Kyowa Interface Science Co., Ltd.) utilizing a platinum plate method.

TABLE 4

Static surface tension

| | | Measured | |
|---|---|---|---|
| | | value of static | |
| | Viscosity | surface tension | |
| | (mPa · s) | (mN/m) | Evaluation |
| Preparation | 7.92 | 20.2 | A |
| Example 1 of | | | |
| Ink | | | |
| Preparation | 8.52 | 20.5 | A |
| Example 2 of | | | |
| Ink | | | |
| Preparation | 8.60 | 19.8 | A |
| Example 3 of | | | |
| Ink | | | |
| Preparation | 8.08 | 21.3 | A |
| Example 4 of | | | |
| Ink | | | |
| Preparation | 7.83 | 22.8 | A |
| Example 5 of | | | |
| Ink | | | |
| Preparation | 7.91 | 22.4 | A |
| Example 6 of | | | |
| Ink | | | |
| Preparation | 8.20 | 24.3 | A |
| Example 7 of | | | |
| Ink | | | |
| Preparation | 8.32 | 25.2 | A |
| Example 8 of | | | |
| Ink | | | |
| Preparation | 8.18 | 21.1 | A |
| Example 9 of | | | |
| Ink | | | |
| Preparation | 8.05 | 21.6 | A |
| Example 10 of | | | |
| Ink | | | |
| Preparation | 7.84 | 21.4 | A |
| Example 11 of | | | |
| Ink | | | |
| Preparation | 7.90 | 21.7 | A |
| Example 12 of | | | |
| Ink | | | |
| Preparation | 7.46 | 27.7 | B |
| Example 13 of | | | |
| Ink | | | |
| Preparation | 7.59 | 28.4 | B |
| Example 14 of | | | |
| Ink | | | |
| Preparation | 8.58 | 36.8 | B |
| Example 15 of | | | |
| Ink | | | |
| Preparation | 8.05 | 36.5 | B |
| Example 16 of | | | |
| Ink | | | |
| Preparation | 8.14 | 38.2 | B |
| Example 17 of | | | |
| Ink | | | |
| Preparation | 8.03 | 37.3 | B |
| Example 18 of | | | |
| Ink | | | |
| Preparation | 8.62 | 16.8 | B |
| Example 19 of | | | |
| Ink | | | |
| Preparation | 8.09 | 17.5 | B |
| Example 20 of | | | |
| Ink | | | |

Examples 1 to 24 and Comparative Examples 1 to 36

The recording method using each ink obtained in the Ink Preparation Examples 1 to 20 is evaluated in the following manner.

Preparation Prior to Printer Evaluation

In an environment of the temperature of from 24.5 to 25.5 degrees C. and 45 to 55 percent RH, the waveform at which ink was most stably discharged was selected for viscosity of each ink and used for all the print evaluation using an inkjet printer (IPSio GXe 330, manufactured by Ricoh Company Ltd.).

The inkjet printer used includes a nozzle plate having nozzles discharging ink droplets, a liquid chamber communicating with the nozzle, a recording head having a pressure generating element serving as a pressure generating device to generate a pressure in the liquid chamber, and a head driver. The head driver selects a drive pulse from the drive waveform including at least one drive pulse in a temporal sequence, generates a discharging pulse corresponding to the size of an ink droplet, applies the discharging pulse to the pressure generating element to discharge the ink droplet from the nozzle hole (slit) and form an image on a recording medium.

The nozzle plate had a repellent film on the surface on the ink discharging side.

When discharging ink droplets from nozzle holes to form an image on a recording medium according to the inkjet recording method of the present disclosure, the drive waveform including at least one drive pulse present in a single print cycle controls discharging at least one ink droplet from the nozzle. In general, the size of an ink droplet is controlled depending on the image formed. When forming a small ink droplet, one drive pulse is included. When forming a middle-sized droplet or a large droplet, multiple drive pulses are included.

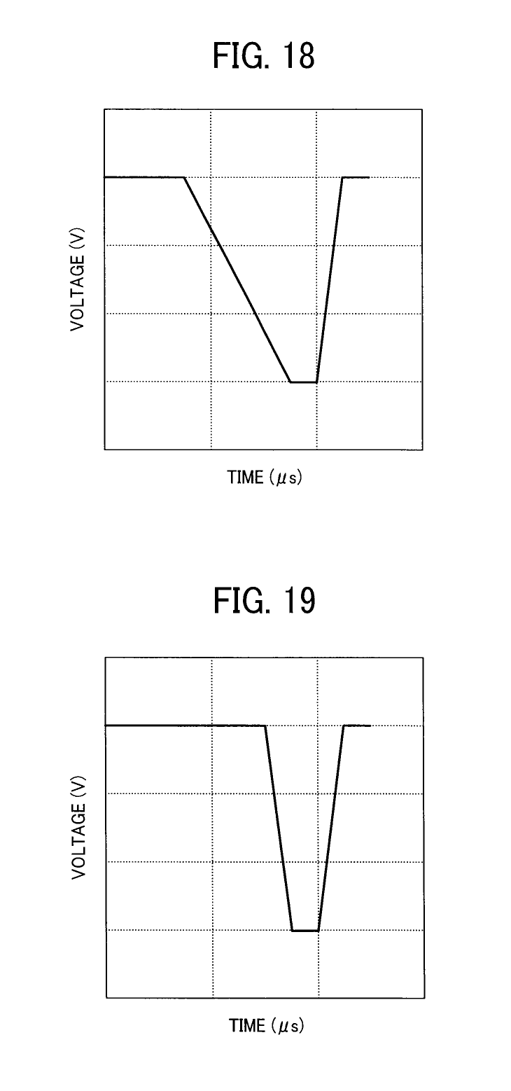

At this point, in the discharging pulse (drive pulse) forming the first droplet in a single print cycle, as illustrated in FIG. 18, the discharging pulse drawing in a meniscus by the inflation waveform element (rising down voltage changing portion in FIG. 18) having a voltage changing time of 1/1 of the resonance period of the liquid in the head is determined as “waveform 1”. Similarly, as illustrated in FIG. 18, the discharging pulse drawing in a meniscus by the inflation waveform element (rising down voltage changing portion in FIG. 18) having a voltage changing time of 1/3 of the resonance period of the liquid in the head is determined as “waveform 2”.

As illustrated in FIG. 19, the discharging pulse drawing in a meniscus by the inflation waveform element having a short voltage changing time of 1/4 of the resonance period of the liquid in the head is determined as “waveform 3”. When using the“waveform 1”, the discharging results of Ink Preparation Examples 1 to 12 are Examples 1 to 12 and the discharging results of Ink Preparation Examples 13 to 20 are Comparative Examples 1 to 8. When using the “waveform 2”, the discharging results of Ink Preparation Examples 1 to 14 are Examples 13 to 24 and the discharging results of Ink Preparation Examples 13 to 20 are Comparative Examples 9 to 16. When using the “waveform 3”, the discharging results of Ink Preparation Examples 1 to 12 are Comparative Examples 17 to 28 and the discharging results of Ink Preparation Examples 13 to 20 are Comparative Examples 29 to 36.

In addition, before the evaluation, ink was attached to the surface of the nozzle plate and the surface was repeatedly wiped off by the wiper blade 4,000 times to intentionally degrade the repellent film on the surface of the nozzle plate.

Discharging Stability

Images were formed on MyPaper (manufactured by Ricoh Company Ltd.) by the inkjet printer (IPSio GXe3300, manufactured by Ricoh Company Ltd.). The print pattern had a printing area of 5 percent for each color in the entire area of the sheet and was printed with each ink 100% duty. The print conditions were that the recording density was 600 dpi with one pass printing and a print sample of the three waveforms of the waveform 1 to the waveform 3 was made. The sample was made by intermittent printing. That is, the print pattern was printed on 20 sheets continuously and the printing operation was halt for 20 minutes without discharging. This cycle was repeated 50 times to print the pattern on 1,000 sheets in total and thereafter the print pattern was printed on one more sheet, which was visually checked to evaluate the image with regard to streaks, dot missing, disturbance of jetting (discharging) of 5 percent chart solid portion.

The evaluation criteria are as follows. “A” is allowed and “B” and “C” are evaluated as failures.

Evaluation Criteria

A: No streaks, no dot missing, no jetting disturbance observed in solid portion

B: Slight streaks, dot missing, and jetting disturbance observed in one or two sites in the solid portion

C: Streaks, dot missing, jetting disturbance observed all over the solid portion

Uniformity of Solid Printed Portion (Uniformity of Solid Portion)

Images were formed on Ricoh Business Coat Gloss (manufactured by Ricoh Company Ltd.) by the inkjet printer (IPSio GXe3300, manufactured by Ricoh Company Ltd.). The print pattern was printed with each ink 100% duty. A print sample of the three waveforms of the waveform 1 to waveform 3 was made.

The uniformity on solid portion of the thus-obtained sample was visually checked and evaluated. The evaluation criteria are as follows. “A” is allowed and “B” and “C” are evaluated as failures.

Evaluation Criteria

A: Mottle observed little on the solid portion

B: Mottle observed slightly on the solid portion

C: Mottle observed all over the solid portion

These evaluation results are shown in Tables 5 to 7. When the static surface tension of each ink is in the range of from 18.0 to 27.0 mN/m, it is evaluated as “A”. When the static surface tension of each ink is outside the range of from 18.0 to 27.0 mN/m, it is evaluated as “B”.

TABLE 5

| | | | | | Uni- |
|---|---|---|---|---|---|
| | | Static | | | formity |
| | | surface | Wave- | Discharging | at solid |
| | Ink | tension | form | stability | portion |
| Example 1 | Preparation | B | 1 | A | A |
| | Example 1 of | | | | |
| | Ink | | | | |
| Example 2 | Preparation | A | 1 | A | A |
| | Example 2 of | | | | |
| | Ink | | | | |
| Example 3 | Preparation | A | 1 | A | A |
| | Example 3 of | | | | |
| | Ink | | | | |
| Example 4 | Preparation | A | 1 | A | A |
| | Example 4 of | | | | |
| | Ink | | | | |
| Example 5 | Preparation | A | 1 | A | A |
| | Example 5 of | | | | |
| | Ink | | | | |
| Example 6 | Preparation | A | 1 | A | A |
| | Example 6 of | | | | |
| | Ink | | | | |
| Example 7 | Preparation | A | 1 | A | A |
| | Example 7 of | | | | |
| | Ink | | | | |
| Example 8 | Preparation | A | 1 | A | A |
| | Example 8 of | | | | |
| | Ink | | | | |
| Example 9 | Preparation | A | 1 | A | A |
| | Example 9 of | | | | |
| | Ink | | | | |
| Example 10 | Preparation | A | 1 | A | A |
| | Example 10 of | | | | |
| | Ink | | | | |
| Example 11 | Preparation | A | 1 | A | A |
| | Example 11 of | | | | |
| | Ink | | | | |
| Example 12 | Preparation | A | 1 | A | A |
| | Example 12 of | | | | |
| | Ink | | | | |
| Comparative | Preparation | D | 1 | B | B |
| Example 1 | Example 13 of | | | | |
| | Ink | | | | |
| Comparative | Preparation | B | 1 | B | B |
| Example 2 | Example 14 of | | | | |
| | Ink | | | | |
| Comparative | Preparation | B | 1 | A | B |
| Example 3 | Example 15 of | | | | |
| | Ink | | | | |
| Comparative | Preparation | B | 1 | A | B |
| Example 4 | Example 16 of | | | | |
| | Ink | | | | |
| Comparative | Preparation | B | 1 | A | B |
| Example 5 | Example 17 of | | | | |
| | Ink | | | | |
| Comparative | Preparation | B | 1 | A | B |
| Example 6 | Example 18 of | | | | |
| | Ink | | | | |
| Comparative | Preparation | B | 1 | B | B |
| Example 7 | Example 19 of | | | | |
| | Ink | | | | |
| Comparative | Preparation | B | 1 | B | B |
| Example 8 | Example 20 of | | | | |
| | Ink | | | | |

TABLE 6

| | | | | | Uni- |
|---|---|---|---|---|---|
| | | Static | | | formity |
| | | surface | Wave- | Discharging | at solid |
| | Ink | tension | form | stability | portion |
| Example 13 | Preparation | A | 2 | A | A |
| | Example 1 of | | | | |
| | Ink | | | | |
| Example 14 | Preparation | A | 2 | A | A |
| | Example 2 of | | | | |
| | Ink | | | | |
| Example 15 | Preparation | A | 2 | A | A |
| | Example 3 of | | | | |
| | Ink | | | | |
| Example 16 | Preparation | A | 2 | A | A |
| | Example 4 of | | | | |
| | Ink | | | | |
| Example 17 | Preparation | A | 2 | A | A |
| | Example 5 of | | | | |
| | Ink | | | | |
| Example 18 | Preparation | A | 2 | A | A |
| | Example 6 of | | | | |
| | Ink | | | | |
| Example 19 | Preparation | A | 2 | A | A |
| | Example 7 of | | | | |
| | Ink | | | | |
| Example 20 | Preparation | A | 2 | A | A |
| | Example 8 of | | | | |
| | Ink | | | | |
| Example 21 | Preparation | A | 2 | A | A |
| | Example 9 of | | | | |
| | Ink | | | | |
| Example 22 | Preparation | A | 2 | A | A |
| | Example 10 of | | | | |
| | Ink | | | | |
| Example 23 | Preparation | A | 2 | A | A |
| | Example 11 of | | | | |
| | Ink | | | | |
| Example 24 | Preparation | A | 2 | A | A |
| | Example 12 of | | | | |
| | Ink | | | | |
| Comparative | Preparation | B | 2 | B | B |
| Example 9 | Example 13 of | | | | |
| | Ink | | | | |
| Comparative | Preparation | B | 2 | B | B |
| Example 10 | Example 14 of | | | | |
| | Ink | | | | |
| Comparative | Preparation | B | 2 | B | B |
| Example 11 | Example 15 of | | | | |
| | Ink | | | | |
| Comparative | Preparation | B | 2 | B | B |
| Example 12 | Example 16 of | | | | |
| | Ink | | | | |
| Comparative | Preparation | B | 2 | B | B |
| Example 13 | Example 17 of | | | | |
| | Ink | | | | |
| Comparative | Preparation | B | 2 | B | B |
| Example 14 | Example 18 of | | | | |
| | Ink | | | | |
| Comparative | Preparation | B | 2 | C | B |
| Example 15 | Example 19 of | | | | |
| | Ink | | | | |
| Comparative | Preparation | B | 2 | C | B |
| Example 16 | Example 20 of | | | | |
| | Ink | | | | |

TABLE 7

| | | | | | Uni- |
|---|---|---|---|---|---|
| | | Static | | | formity |
| | | surface | Wave- | Discharging | at solid |
| | Ink | tension | form | stability | portion |
| Comparative | Preparation | A | 3 | C | B |
| Example 17 | Example 1 of | | | | |
| | Ink | | | | |
| Comparative | Preparation | A | 3 | C | B |
| Example 18 | Example 2 of | | | | |
| | Ink | | | | |
| Comparative | Preparation | A | 3 | C | B |
| Example 19 | Example 3 of | | | | |
| | Ink | | | | |
| Comparative | Preparation | A | 3 | C | B |
| Example 20 | Example 4 of | | | | |
| | Ink | | | | |
| Comparative | Preparation | A | 3 | C | B |
| Example 21 | Example 5 of | | | | |
| | Ink | | | | |
| Comparative | Preparation | A | 3 | C | B |
| Example 22 | Example 6 of | | | | |
| | Ink | | | | |
| Comparative | Preparation | A | 3 | C | B |
| Example 23 | Example 7 of | | | | |
| | Ink | | | | |
| Comparative | Preparation | A | 3 | C | B |
| Example 24 | Example 8 of | | | | |
| | Ink | | | | |
| Comparative | Preparation | A | 3 | C | B |
| Example 25 | Example 9 of | | | | |
| | Ink | | | | |
| Comparative | Preparation | A | 3 | C | B |
| Example 26 | Example 10 of | | | | |
| | Ink | | | | |
| Comparative | Preparation | A | 3 | C | B |
| Example 27 | Example 11 of | | | | |
| | Ink | | | | |
| Comparative | Preparation | A | 3 | C | B |
| Example 28 | Example 12 of | | | | |
| | Ink | | | | |
| Comparative | Preparation | B | 3 | C | C |
| Example 29 | Example 13 of | | | | |
| | Ink | | | | |
| Comparative | Preparation | B | 3 | C | C |
| Example 30 | Example 14 of | | | | |
| | Ink | | | | |
| Comparative | Preparation | B | 3 | C | C |
| Example 31 | Example 15 of | | | | |
| | Ink | | | | |
| Comparative | Preparation | B | 3 | C | C |
| Example 32 | Example 16 of | | | | |
| | Ink | | | | |
| Comparative | Preparation | B | 3 | B | C |
| Example 33 | Example 17 of | | | | |
| | Ink | | | | |
| Comparative | Preparation | B | 3 | B | C |
| Example 34 | Example 18 of | | | | |
| | Ink | | | | |
| Comparative | Preparation | B | 3 | C | B |
| Example 35 | Example 19 of | | | | |
| | Ink | | | | |
| Comparative | Preparation | B | 3 | C | B |
| Example 36 | Example 20 of | | | | |
| | Ink | | | | |

1. Discharging Stability Evaluation:

According to Examples 1 to 24, it is found that when a drive pulse (discharging pulse) having an inflation waveform element (rising down voltage changing portion) having a time (voltage changing time) of 1/3 or more of the resonance period of the liquid chamber is used, good discharging stability is obtained even for ink having low static surface tension.

2. Discharging Stability Evaluation:

By the comparison between Examples 1 to 24 and Comparative Examples 17 to 28, it is found that ink having low static surface tension comes to have good discharging stability when a drive pulse (discharging pulse) having an inflation waveform element (rising down voltage changing portion) having a time (voltage changing time) of 1/3 or more of the resonance period of the liquid chamber is used.

3. Evaluation on Uniformity of Solid Portion:

By the comparison between Examples 1 to 12 and Comparative Examples 1 to 8, it is found that unless the value of the static surface tension satisfies the condition, uniformity in the solid portion is inferior. This is because if the value of the static surface tension satisfies the condition, ink permeates into a sheet soon due to the low static surface tension after the ink has landed on the sheet, thereby preventing beading to occur. If the value of static surface tension is too low, the discharging stability is worsened, which has an adverse impact on uniformity in a solid portion.

Ink Preparation Examples 21 to 42

Each pigment dispersion manufactured in Manufacturing Examples 1 to 4 of Pigment Dispersion was used to prepare each ink of Ink Preparation Examples 21 to 42 according to the prescriptions shown in Tables 8 to 10 in the same manner as in Ink Preparation Example 1 and pH was adjusted to 9 by 10 percent aqueous solution of sodium hydroxide.

The values in Tables 8 to 10 is represented in percent by mass and the abbreviations are the same as those in Table 1.

TABLE 8

| | | Preparation examples of ink | | | | | | | |
|---|---|---|---|---|---|---|---|---|---|
| | | 21 | 22 | 23 | 24 | 25 | 26 | 27 | 28 |
| Manufacturing | C | 38.0 | | | | 26.0 | | | |
| Example 1 of | | | | | | | | | |
| dispersion | | | | | | | | | |
| Manufacturing | M | | 42.0 | | | | 30.0 | | |
| Example 2 of | | | | | | | | | |
| dispersion | | | | | | | | | |
| Manufacturing | Y | | | 38.0 | | | | 22.0 | |
| Example 3 of | | | | | | | | | |
| dispersion | | | | | | | | | |
| Manufacturing | K | | | | 43.0 | | | | 27.0 |
| Example 4 of | | | | | | | | | |
| dispersion | | | | | | | | | |
| Surfactant | Surfactant A | 0.04 | 0.04 | 0.05 | 0.03 | 0.03 | 0.03 | 0.03 | 0.02 |
| | Surfactant B | | | | | | | | |
| | Surfactant C | | | | | | | | |
| | Surfactant D | | | | | | | | |
| Water-soluble | Glycerin | | | | | 12.0 | 11.0 | 13.0 | 10.0 |
| organic solvent | 3-methyl-1,3- | | | | | 24.0 | | | |
| | butane diol | | | | | | | | |
| | 1,3-butane diol | | | 10.0 | | | | | |
| | 1,2-butane diol | 7.0 | 40.0 | | 13.0 | | | | |
| | 1,2-propanediol | 28.0 | | 30.0 | 26.0 | | | 26.0 | |
| | 1,6-hexane diol | | | | | | 22.0 | | |
| | 1,5-pentane diol | | | | | | | | 25.0 |
| | 2-pyrroridone | | | | | | | | |
| Foam | 2,4,7,9- | 0.25 | 0.25 | 0.25 | 0.25 | 0.15 | 0.15 | 0.15 | 0.15 |
| inhibitor | tetramethyldecane- | | | | | | | | |
| | 4,7-diol | | | | | | | | |
| Defoaming | KM-72F | | | | | | | | |
| agent | | | | | | | | | |
| Permeating | 2-ethyl-1,3- | 3.0 | 3.0 | 3.0 | 3.0 | 4.0 | 4.0 | 4.0 | 4.0 |
| agent | hexanediol | | | | | | | | |
| Fungicides | PROXEL LV | 0.20 | 0.20 | 0.20 | 0.20 | 0.10 | 0.10 | 0.10 | 0.10 |
| pH | 10 percent | Proper | Proper | Proper | Proper | Proper | Proper | Proper | Proper |
| regulator | aqueous solution | quantity | quantity | quantity | quantity | quantity | quantity | quantity | quantity |
| | of sodium | | | | | | | | |
| | hydroxide | | | | | | | | |
| Deionized | | Rest | Rest | Rest | Rest | Rest | Rest | Rest | Rest |
| water | | | | | | | | | |
| Total | | 100.0 | 100.0 | 100.0 | 100.0 | 100.0 | 100.0 | 100.0 | 100.0 |

TABLE 9

| | | Preparation examples of ink | | | | | | | |
|---|---|---|---|---|---|---|---|---|---|
| | | 29 | 30 | 31 | 32 | 33 | 34 | 35 | 36 |
| Manufacturing | C | 17.0 | | | | 15.0 | | | |
| Example 1 of | | | | | | | | | |
| dispersion | | | | | | | | | |
| Manufacturing | M | | 21.0 | | | | 20.0 | | |
| Example 2 of | | | | | | | | | |
| dispersion | | | | | | | | | |
| Manufacturing | Y | | | 15.0 | | | | 15.0 | |
| Example 3 of | | | | | | | | | |
| dispersion | | | | | | | | | |
| Manufacturing | K | | | | 21.0 | | | | 25.0 |
| Example 4 of | | | | | | | | | |
| dispersion | | | | | | | | | |
| Surfactant | Surfactant A | | | | | | | | |
| | Surfactant B | 5.00 | 5.00 | 5.00 | 5.00 | | | | |
| | Surfactant C | | | | | 0.50 | 0.50 | 0.50 | 0.40 |
| | Surfactant D | | | | | | | | |
| Water-soluble | Glycerin | 20.0 | 25.0 | 30.0 | 15.0 | 5.0 | 5.0 | 5.0 | 5.0 |
| organic solvent | 3-methyl-1,3- | | 22.0 | | | | | | |
| | butane diol | | | | | | | | |
| | 1,3-butane diol | | | | 15.0 | | | | |
| | 1,2-butane diol | 28.0 | | | | | | | |
| | 1,2-propanediol | | | 15.0 | 5.0 | | | | |
| | 1,6-hexane diol | | | | | 20.0 | 20.0 | | |
| | 1,5-pentane diol | | | | | | | 23.0 | 23.0 |
| | 2-pyrroridone | | | | | 2.0 | 2.0 | 2.0 | 2.0 |
| Foam | 2,4,7,9- | | | | | 0.25 | 0.25 | 0.25 | 0.25 |
| inhibitor | tetramethyldecane- | | | | | | | | |
| | 4,7-diol | | | | | | | | |
| Defoaming | KM-72F | 1.50 | 1.50 | 1.50 | 1.50 | | | | |
| agent | | | | | | | | | |
| Permeating | 2-ethyl-1,3- | 3.0 | 3.0 | 3.0 | 3.0 | 2.5 | 2.5 | 2.5 | 2.5 |
| agent | hexanediol | | | | | | | | |
| Fungicides | PROXEL LV | 0.20 | 0.20 | 0.20 | 0.20 | 0.20 | 0.20 | 0.20 | 0.20 |
| pH | 10 percent | Proper | Proper | Proper | Proper | Proper | Proper | Proper | Proper |
| regulator | aqueous solution | quantity | quantity | quantity | quantity | quantity | quantity | quantity | quantity |
| | of sodium | | | | | | | | |
| | hydroxide | | | | | | | | |
| Deionized | | Rest | Rest | Rest | Rest | Rest | Rest | Rest | Rest |
| water | | | | | | | | | |
| Total | | 100.0 | 100.0 | 100.0 | 100.0 | 100.0 | 100.0 | 100.0 | 100.0 |

TABLE 10

| | | Preparation examples of ink | | | | | |
|---|---|---|---|---|---|---|---|
| | | 37 | 38 | 39 | 40 | 41 | 42 |
| Manufacturing | C | 20.0 | | | | | |
| Example 1 of | | | | | | | |
| dispersion | | | | | | | |
| Manufacturing | M | | 25.0 | | | | |
| Example 2 of | | | | | | | |
| dispersion | | | | | | | |
| Manufacturing | Y | | | 22.0 | | | |
| Example 3 of | | | | | | | |
| dispersion | | | | | | | |
| Manufacturing | K | | | | 27.0 | 43.0 | 43.0 |
| Example 4 of | | | | | | | |
| dispersion | | | | | | | |
| Surfactant | Surfactant A | | | | | 0.15 | 0.005 |
| | Surfactant B | | | | | | |
| | Surfactant C | | | | | | |
| | Surfactant D | 1.20 | 1.20 | 1.20 | 1.20 | | |
| Water-soluble | Glycerin | 13.0 | 13.0 | 13.0 | 13.0 | | |
| organic solvent | 3-methyl-1,3- | | | | 26.0 | | |
| | butane diol | | | | | | |
| | 1,3-butane diol | | | | | | |
| | 1,2-butane diol | | 22.0 | | | 13.0 | 13.0 |
| | 1,2-propanediol | 20.0 | | | | 26.0 | 26.0 |
| | 1,6-hexane diol | | | 25.0 | | | |
| | 1,5-pentane diol | | | | | | |
| | 2-pyrroridone | | | | | | |
| Foam | 2,4,7,9- | | | | | 0.25 | 0.25 |
| inhibitor | tetramethyldecane- | | | | | | |
| | 4,7-diol | | | | | | |
| Defoaming | KM-72F | 0.40 | 0.40 | 0.40 | 0.40 | | |
| agent | | | | | | | |
| Permeating | 2-ethyl-1,3- | 2.0 | 2.0 | 2.0 | 2.0 | 3.0 | 3.0 |
| agent | hexanediol | | | | | | |
| Fungicides | PROXEL LV | 0.25 | 0.25 | 0.25 | 0.25 | 0.20 | 0.20 |
| pH | 10 percent | Proper | Proper | Proper | Proper | Proper | Proper |
| regulator | aqueous solution | quantity | quantity | quantity | quantity | quantity | quantity |
| | of sodium | | | | | | |
| | hydroxide | | | | | | |
| Deionized | | Rest | Rest | Rest | Rest | Rest | Rest |
| water | | | | | | | |
| Total | | 100.0 | 100.0 | 100.0 | 100.0 | 100.0 | 100.0 |

Property of Ink

Viscosity and static surface tension were measured for each ink of the Ink Preparation Examples 21 to 42 in the same manner as in Ink Preparation Example 1. The results are shown in Table 11.

TABLE 11

| | | Static | |
|---|---|---|---|
| | Viscosity | surface tension | Static |
| | (mPa · s) | (mN/m) | surface tension |
| Preparation Example 21 | 8.03 | 22.1 | A |
| of Ink | | | |
| Preparation Example 22 | 8.49 | 22.4 | A |
| of Ink | | | |
| Preparation Example 23 | 8.41 | 20.2 | A |
| of Ink | | | |
| Preparation Example 24 | 8.27 | 23.3 | A |
| of Ink | | | |
| Preparation Example 25 | 7.89 | 22.4 | A |
| of Ink | | | |
| Preparation Example 26 | 8.12 | 22.9 | A |
| of Ink | | | |
| Preparation Example 27 | 8.22 | 21.6 | A |
| of Ink | | | |
| Preparation Example 28 | 8.18 | 24.1 | A |
| of Ink | | | |
| Preparation Example 29 | 8.07 | 18.9 | A |
| of Ink | | | |
| Preparation Example 30 | 8.38 | 18.8 | A |
| of Ink | | | |
| Preparation Example 31 | 8.12 | 19.0 | A |
| of Ink | | | |
| Preparation Example 32 | 7.88 | 20.3 | A |
| of Ink | | | |
| Preparation Example 33 | 7.25 | 20.7 | A |
| of Ink | | | |
| Preparation Example 34 | 7.33 | 21.1 | A |
| of Ink | | | |
| Preparation Example 35 | 7.40 | 20.7 | A |
| of Ink | | | |
| Preparation Example 36 | 7.52 | 21.8 | A |
| of Ink | | | |
| Preparation Example 37 | 7.48 | 29.2 | B |
| of Ink | | | |
| Preparation Example 38 | 7.63 | 29.4 | B |
| of Ink | | | |
| Preparation Example 39 | 7.62 | 29.1 | B |
| of Ink | | | |
| Preparation Example 40 | 7.74 | 29.7 | B |
| of Ink | | | |
| Preparation Example 41 | 8.35 | 17.8 | B |
| of Ink | | | |
| Preparation Example 42 | 8.12 | 34.8 | B |
| of Ink | | | |

The inks obtained in Ink Preparation Examples 21 to 42 were used to prepare Ink Sets 1 to 7 having combinations shown in Table 12.

TABLE 12

| | | |
|---|---|---|
| Ink set 1 | C | Preparation Example 21 |
| | | of Ink |
| | M | Preparation Example 22 |
| | | of Ink |
| | Y | Preparation Example 23 |
| | | of Ink |
| | K | Preparation Example 24 |
| | | of Ink |
| Ink set 2 | C | Preparation Example 25 |
| | | of Ink |
| | M | Preparation Example 26 |
| | | of Ink |
| | Y | Preparation Example 27 |
| | | of Ink |
| | K | Preparation Example 28 |
| | | of Ink |
| Ink set 3 | C | Preparation Example 29 |
| | | of Ink |
| | M | Preparation Example 30 |
| | | of Ink |
| | Y | Preparation Example 31 |
| | | of Ink |
| | K | Preparation Example 32 |
| | | of Ink |
| Ink set 4 | C | Preparation Example 33 |
| | | of Ink |
| | M | Preparation Example 34 |
| | | of Ink |
| | Y | Preparation Example 35 |
| | | of Ink |
| | K | Preparation Example 36 |
| | | of Ink |
| Ink set 5 | C | Preparation Example 21 |
| | | of Ink |
| | M | Preparation Example 22 |
| | | of Ink |
| | Y | Preparation Example 23 |
| | | of Ink |
| | K | Preparation Example 41 |
| | | of Ink |
| Ink set 6 | C | Preparation Example 21 |
| | | of Ink |
| | M | Preparation Example 22 |
| | | of Ink |
| | Y | Preparation Example 23 |
| | | of Ink |
| | K | Preparation Example 42 |
| | | of Ink |
| Ink set 7 | C | Preparation Example 37 |
| | | of Ink |
| | M | Preparation Example 38 |
| | | of Ink |
| | Y | Preparation Example 39 |
| | | of Ink |
| | K | Preparation Example 40 |
| | | of Ink |

Examples 25 to 32 and Comparative Examples 37 to 49

The recording methods using each of the ink sets 1 to 7 are evaluated in the following manner.

The ink sets were evaluated in the same recording method as in Example 1 using the same inkjet printer as Example 1 except that the following was changed.

Prior to the discharging pulse forming the first droplet in a single print cycle, as illustrated in FIG. 18, the discharging pulse drawing in a meniscus by the inflation waveform element (rising down voltage changing portion) having a voltage changing time of 1/1 of the resonance period of the liquid in the head is determined as “waveform 1”. Similarly, as illustrated in FIG. 18, the discharging pulse drawing in a meniscus by the inflation waveform element (rising down voltage changing portion in FIG. 18) having a voltage changing time of 1/3 of the resonance period of the liquid in the head is determined as “waveform 2”.

As illustrated in FIG. 19, the discharging pulse drawing in a meniscus by the inflation waveform element having a short voltage changing time of 1/4 of the resonance period of the liquid in the head is determined as “waveform 3”. When using the “waveform 1”, the discharging results of Ink Sets 1 to 4 are Examples 25 to 28 and the discharging results of Ink Sets 5 to 7 are Comparative Examples 37 to 39. When using the “waveform 2”, the discharging results of Ink Sets 29 to 32 are Examples 29 to 32 and the discharging results of Ink Sets 5 to 7 are Comparative Examples 40 to 42. When using the “waveform 3”, the discharging results of Ink Sets 1 to 4 are Examples 43 to 46 and the discharging results of Ink Sets 5 to 7 are Comparative Examples 47 to 49. In addition, before the evaluation, ink was attached to the surface of the nozzle plate and the surface was repeatedly wiped off by the wiper blade 4,000 times as in Example 1 to intentionally degrade the repellent film on the surface of the nozzle plate.

Discharging Stability

Images were formed on MyPaper (manufactured by Ricoh Company Ltd.) by the inkjet printer (IPSio GXe3300, manufactured by Ricoh Company Ltd.). The print pattern had a print area of 5 percent for each color in the entire area of the sheet and was printed with each ink 100% duty. The print conditions were that the recording density was 600 dpi with one pass printing and a print sample of the three waveforms of the waveform 1 to the waveform 3 was made. The sample was made by intermittent printing. That is, the print pattern was printed on 20 sheets continuously and the printing operation was halt for 20 minutes without discharging. This cycle was repeated 50 times to print the pattern on 1,000 sheets in total and thereafter the print pattern was printed on one more sheet, which was visually checked to evaluate the image with regard to streaks, dot missing, disturbance of jetting (discharging) of 5 percent chart solid portion.

The evaluation criteria are as follows. “A” is allowed and “B” and “C” are evaluated as failures.

Evaluation Criteria

A: No streaks, no dot missing, no jetting disturbance observed in the solid portion

B: Slight streaks, dot missing, and jetting disturbance observed in one or two sites

C: Streaks, dot missing, jetting disturbance observed all over the solid portion

Uniformity of Solid Printed Portion (Uniformity of Solid Portion)

Images were formed on Ricoh Business Coat Gloss (manufactured by Ricoh Company Ltd.) by the inkjet printer (IPSio GXe3300, manufactured by Ricoh Company Ltd.). The print pattern was printed with each ink 100% duty. A print sample of the three waveforms of the waveform 1 to waveform 3 was made.

The uniformity on a solid portion of the thus-obtained sample was visually checked and evaluated. The evaluation criteria are as follows. “A” is allowed and “B” and “C” are evaluated as failures.

### Evaluation Criteria

A: Mottle observed little on the solid portion

B: Mottle observed slightly on the solid portion

C: Mottle observed all over the solid portion

Evaluation on Bleed between Black Ink and Color Ink

Only “waveform 1” was evaluated. Images were formed on MyPaper (manufactured by Ricoh Company Ltd.) by the inkjet printer (IPSio GXe3300, manufactured by Ricoh Company Ltd.). The print pattern was printed with each color ink 100% duty. The print conditions were that the recording density was 600 dpi with one pass printing. The sample was made using only the “waveform 1”.

Texts in black ink were printed in the solid image of each color ink and bleed between color ink and black ink was visually checked and evaluated according to the following criteria. “A” is allowed and “B” and “C” are evaluated as failures.

Evaluation Criteria

A: Free of bleed and texts in black clearly recognized (with no bleed)

B: Bleed slightly occurred with slight bleed of texts in black

C: Bleed occurred and texts in black almost unrecognizable

These evaluation results are shown in Tables 13 to 16. In addition, when the static surface tension of each ink was in the range of from 18.0 to 27.0 mN/m, it was evaluated as A. When the static surface tension of each ink was outside the range of from 18.0 to 27.0 mN/m, it was evaluated as B.

Furthermore, when the difference obtained by subtracting the static surface tension of any color ink from the static surface tension of the black ink was from 0 to 4 mN/m, the evaluation was determined as “A” and when the difference obtained by subtracting the static surface tension of any color ink from the static surface tension of the black ink was outside the range of from 0 to 4 mN/m, the evaluation was determined as “B”.

TABLE 13

| | | | Static surface | | Difference in static | |
|---|---|---|---|---|---|---|
| | | | tension | | surface tension between | |
| | | | Measured | | black in and | |
| | | | value of | | color ink | |
| | | | static | | Value | |
| | | | surface | | of | |
| Ink | | | tension | Evalu- | difference | Evalu- |
| set | Combination of ink | | (mN/m) | ation | (mN/m) | ation |
| Ink | C | Preparation | 22.1 | A | 1.2 | A |
| set | | Example 21 of | | | | |
| 1 | | Ink | | | | |
| | M | Preparation | 22.4 | A | 0.9 | |
| | | Example 22 of | | | | |
| | | Ink | | | | |
| | Y | Preparation | 20.2 | A | 3.1 | |
| | | Example 23 of | | | | |
| | | Ink | | | | |
| | K | Preparation | 23.3 | A | — | |
| | | Example 24 of | | | | |
| | | Ink | | | | |
| Ink | C | Preparation | 22.4 | A | 1.7 | A |
| set | | Example 25 of | | | | |
| 2 | | Ink | | | | |
| | M | Preparation | 22.9 | A | 1.2 | |
| | | Example 26 of | | | | |
| | | Ink | | | | |
| | Y | Preparation | 21.6 | A | 2.5 | |
| | | Example 27 of | | | | |
| | | Ink | | | | |
| | K | Preparation | 24.1 | A | — | |
| | | Example 28 of | | | | |
| | | Ink | | | | |
| Ink | C | Preparation | 18.9 | A | 1.4 | A |
| set | | Example 29 of | | | | |
| 3 | | Ink | | | | |
| | M | Preparation | 18.8 | A | 1.5 | |
| | | Example 30 of | | | | |
| | | Ink | | | | |
| | Y | Preparation | 19.0 | A | 1.3 | |
| | | Example 31 of | | | | |
| | | Ink | | | | |
| | K | Preparation | 20.3 | A | — | |
| | | Example 32 of | | | | |
| | | Ink | | | | |
| Ink | C | Preparation | 20.7 | A | 1.1 | A |
| set | | Example 33 of | | | | |
| 4 | | Ink | | | | |
| | M | Preparation | 21.1 | A | 0.7 | |
| | | Example 34 of | | | | |
| | | Ink | | | | |
| | Y | Preparation | 20.7 | A | 1.1 | |
| | | Example 35 of | | | | |
| | | Ink | | | | |
| | K | Preparation | 21.8 | A | — | |
| | | Example 36 of | | | | |
| | | Ink | | | | |
| Ink | C | Preparation | 22.1 | A | −4.3 | D |
| set | | Example 21 of | | | | |
| 5 | | Ink | | | | |
| | M | Preparation | 22.4 | A | −4.6 | |
| | | Example 22 of | | | | |
| | | Ink | | | | |
| | Y | Preparation | 20.2 | A | −2.4 | |
| | | Example 23 of | | | | |
| | | Ink | | | | |
| | K | Preparation | 17.8 | D | — | |
| | | Example 41 of | | | | |
| | | Ink | | | | |
| Ink | C | Preparation | 22.1 | A | 12.7 | D |
| set | | Example 21 of | | | | |
| 6 | | Ink | | | | |
| | M | Preparation | 22.4 | A | 12.4 | |
| | | Example 22 of | | | | |
| | | Ink | | | | |
| | Y | Preparation | 20.2 | A | 14.6 | |
| | | Example 23 of | | | | |
| | | Ink | | | | |
| | K | Preparation | 34.8 | D | — | |
| | | Example 42 of | | | | |
| | | Ink | | | | |
| Ink | C | Preparation | 29.2 | D | 0.5 | A |
| set | | Example 37 of | | | | |
| 7 | | Ink | | | | |
| | M | Preparation | 29.4 | D | 0.3 | |
| | | Example 38 of | | | | |
| | | Ink | | | | |
| | Y | Preparation | 29.1 | D | 0.6 | |
| | | Example 39 of | | | | |
| | | Ink | | | | |
| | K | Preparation | 29.7 | D | — | |
| | | Example 40 of | | | | |
| | | Ink | | | | |

TABLE 14

| | | | | | | | Bleed |
|---|---|---|---|---|---|---|---|
| | | | | | | Uni- | be- |
| | | | | | Dis- | formity | tween |
| | | | | | charg- | at | black |
| | Wave- | | | | ing | solid | and |
| | form | Ink set | | | stability | portion | color |
| Example | 1 | Ink | C | Preparation | A | A | A |
| 25 | | set | | Example 21 of | | | |
| | | 1 | | Ink | | | |
| | | | M | Preparation | A | A | A |
| | | | | Example 22 of | | | |
| | | | | Ink | | | |
| | | | Y | Preparation | A | A | A |
| | | | | Example 23 of | | | |
| | | | | Ink | | | |
| | | | K | Preparation | A | A | — |
| | | | | Example 24 of | | | |
| | | | | Ink | | | |
| Example | 1 | Ink | C | Preparation | A | A | A |
| 26 | | set | | Example 25 of | | | |
| | | 2 | | Ink | | | |
| | | | M | Preparation | A | A | A |
| | | | | Example 26 of | | | |
| | | | | Ink | | | |
| | | | Y | Preparation | A | A | A |
| | | | | Example 27 of | | | |
| | | | | Ink | | | |
| | | | K | Preparation | A | A | — |
| | | | | Example 28 of | | | |
| | | | | Ink | | | |
| Example | 1 | Ink | C | Preparation | A | A | A |
| 27 | | set | | Example 29 of | | | |
| | | 3 | | Ink | | | |
| | | | M | Preparation | A | A | A |
| | | | | Example 30 of | | | |
| | | | | Ink | | | |
| | | | Y | Preparation | A | A | A |
| | | | | Example 31 of | | | |
| | | | | Ink | | | |
| | | | K | Preparation | A | A | — |
| | | | | Example 32 of | | | |
| | | | | Ink | | | |
| Example | 1 | Ink | C | Preparation | A | A | A |
| 28 | | set | | Example 33 of | | | |
| | | 4 | | Ink | | | |
| | | | M | Preparation | A | A | A |
| | | | | Example 34 of | | | |
| | | | | Ink | | | |
| | | | Y | Preparation | A | A | A |
| | | | | Example 35 of | | | |
| | | | | Ink | | | |
| | | | K | Preparation | A | A | — |
| | | | | Example 36 of | | | |
| | | | | Ink | | | |
| Compar- | 1 | Ink | C | Preparation | A | A | C |
| ative | | set | | Example 21 of | | | |
| Example | | 5 | | Ink | | | |
| 37 | | | M | Preparation | A | A | C |
| | | | | Example 22 of | | | |
| | | | | Ink | | | |
| | | | Y | Preparation | A | A | C |
| | | | | Example 23 of | | | |
| | | | | Ink | | | |
| | | | K | Preparation | B | B | — |
| | | | | Example 41 of | | | |
| | | | | Ink | | | |
| Compar- | 1 | Ink | C | Preparation | A | A | B |
| ative | | set | | Example 21 of | | | |
| Example | | 6 | | Ink | | | |
| 38 | | | M | Preparation | A | A | B |
| | | | | Example 22 of | | | |
| | | | | Ink | | | |
| | | | Y | Preparation | A | A | B |
| | | | | Example 23 of | | | |
| | | | | Ink | | | |
| | | | K | Preparation | A | B | — |
| | | | | Example 42 of | | | |
| | | | | Ink | | | |
| Compar- | 1 | Ink | C | Preparation | B | B | A |
| ative | | set | | Example 37 of | | | |
| Example | | 7 | | Ink | | | |
| 39 | | | M | Preparation | B | B | A |
| | | | | Example 38 of | | | |
| | | | | Ink | | | |
| | | | Y | Preparation | B | B | A |
| | | | | Example 39 of | | | |
| | | | | Ink | | | |
| | | | K | Preparation | B | B | — |
| | | | | Example 40 of | | | |
| | | | | Ink | | | |

TABLE 15

| | | | | | | Uni- |
|---|---|---|---|---|---|---|
| | | | | | Dis- | formity |
| | | | | | charg- | at |
| | Wave- | | | | ing | solid |
| | form | Ink set | | | stability | portion |
| Example | 2 | Ink | C | Preparation | A | A |
| 29 | | set | | Example 21 of | | |
| | | 1 | | Ink | | |
| | | | M | Preparation | A | A |
| | | | | Example 22 of | | |
| | | | | Ink | | |
| | | | Y | Preparation | A | A |
| | | | | Example 23 of | | |
| | | | | Ink | | |
| | | | K | Preparation | A | A |
| | | | | Example 24 of | | |
| | | | | Ink | | |
| Example | 2 | Ink | C | Preparation | A | A |
| 30 | | set | | Example 25 of | | |
| | | 2 | | Ink | | |
| | | | M | Preparation | A | A |
| | | | | Example 26 of | | |
| | | | | Ink | | |
| | | | Y | Preparation | A | A |
| | | | | Example 27 of | | |
| | | | | Ink | | |
| | | | K | Preparation | A | A |
| | | | | Example 28 of | | |
| | | | | Ink | | |
| Example | 2 | Ink | C | Preparation | A | A |
| 31 | | set | | Example 29 of | | |
| | | 3 | | Ink | | |
| | | | M | Preparation | A | A |
| | | | | Example 30 of | | |
| | | | | Ink | | |
| | | | Y | Preparation | A | A |
| | | | | Example 31 of | | |
| | | | | Ink | | |
| | | | K | Preparation | A | A |
| | | | | Example 32 of | | |
| | | | | Ink | | |
| Example | 2 | Ink | C | Preparation | A | A |
| 32 | | set | | Example 33 of | | |
| | | 4 | | Ink | | |
| | | | M | Preparation | A | A |
| | | | | Example 34 of | | |
| | | | | Ink | | |
| | | | Y | Preparation | A | A |
| | | | | Example 35 of | | |
| | | | | Ink | | |
| | | | K | Preparation | A | A |
| | | | | Example 36 of | | |
| | | | | Ink | | |
| Compar- | 2 | Ink | C | Preparation | A | A |
| ative | | set | | Example 21 of | | |
| Example | | 5 | | Ink | | |
| 40 | | | M | Preparation | A | A |
| | | | | Example 22 of | | |
| | | | | Ink | | |
| | | | Y | Preparation | A | A |
| | | | | Example 23 of | | |
| | | | | Ink | | |
| | | | K | Preparation | B | B |
| | | | | Example 41 of | | |
| | | | | Ink | | |
| Compar- | 2 | Ink | C | Preparation | A | A |
| ative | | set | | Example 21 of | | |
| Example | | 6 | | Ink | | |
| 41 | | | M | Preparation | A | A |
| | | | | Example 22 of | | |
| | | | | Ink | | |
| | | | Y | Preparation | A | A |
| | | | | Example 23 of | | |
| | | | | Ink | | |
| | | | K | Preparation | B | B |
| | | | | Example 42 of | | |
| | | | | Ink | | |
| Compar- | 2 | Ink | C | Preparation | C | C |
| ative | | set | | Example 37 of | | |
| Example | | 7 | | Ink | | |
| 42 | | | M | Preparation | C | C |
| | | | | Example 38 of | | |
| | | | | Ink | | |
| | | | Y | Preparation | C | C |
| | | | | Example 39 of | | |
| | | | | Ink | | |
| | | | K | Preparation | C | C |
| | | | | Example 40 of | | |
| | | | | Ink | | |

TABLE 16

| | | | | | | Uni- |
|---|---|---|---|---|---|---|
| | | | | | Dis- | formity |
| | | | | | charg- | at |
| | Wave- | | | | ing | solid |
| | form | Ink set | | | stability | portion |
| Compar- | 3 | Ink | C | Preparation | C | B |
| ative | | set | | Example 21 of | | |
| Example | | 1 | | Ink | | |
| 43 | | | M | Preparation | C | B |
| | | | | Example 22 of | | |
| | | | | Ink | | |
| | | | Y | Preparation | C | B |
| | | | | Example 23 of | | |
| | | | | Ink | | |
| | | | K | Preparation | C | B |
| | | | | Example 24 of | | |
| | | | | Ink | | |
| Compar- | 3 | Ink | C | Preparation | C | B |
| ative | | set | | Example 25 of | | |
| Example | | 2 | | Ink | | |
| 44 | | | M | Preparation | C | B |
| | | | | Example 26 of | | |
| | | | | Ink | | |
| | | | Y | Preparation | C | B |
| | | | | Example 27 of | | |
| | | | | Ink | | |
| | | | K | Preparation | C | B |
| | | | | Example 28 of | | |
| | | | | Ink | | |
| Compar- | 3 | Ink | C | Preparation | C | B |
| ative | | set | | Example 29 of | | |
| Example | | 3 | | Ink | | |
| 45 | | | M | Preparation | C | B |
| | | | | Example 30 of | | |
| | | | | Ink | | |
| | | | Y | Preparation | C | B |
| | | | | Example 31 of | | |
| | | | | Ink | | |
| | | | K | Preparation | C | B |
| | | | | Example 32 of | | |
| | | | | Ink | | |
| Compar- | 3 | Ink | C | Preparation | C | B |
| ative | | set | | Example 33 of | | |
| Example | | 4 | | Ink | | |
| 46 | | | M | Preparation | C | B |
| | | | | Example 34 of | | |
| | | | | Ink | | |
| | | | Y | Preparation | C | B |
| | | | | Example 35 of | | |
| | | | | Ink | | |
| | | | K | Preparation | C | B |
| | | | | Example 36 of | | |
| | | | | Ink | | |
| Compar- | 3 | Ink | C | Preparation | C | B |
| ative | | set | | Example 21 of | | |
| Example | | 5 | | Ink | | |
| 47 | | | M | Preparation | C | B |
| | | | | Example 22 of | | |
| | | | | Ink | | |
| | | | Y | Preparation | C | B |
| | | | | Example 23 of | | |
| | | | | Ink | | |
| | | | K | Preparation | C | B |
| | | | | Example 41 of | | |
| | | | | Ink | | |
| Compar- | 3 | Ink | C | Preparation | C | B |
| ative | | set | | Example 21 of | | |
| Example | | 6 | | Ink | | |
| 48 | | | M | Preparation | C | B |
| | | | | Example 22 of | | |
| | | | | Ink | | |
| | | | Y | Preparation | C | B |
| | | | | Example 23 of | | |
| | | | | Ink | | |
| | | | K | Preparation | C | C |
| | | | | Example 42 of | | |
| | | | | Ink | | |
| Compar- | 3 | Ink | C | Preparation | C | C |
| ative | | set | | Example 37 of | | |
| Example | | 7 | | Ink | | |
| 49 | | | M | Preparation | C | C |
| | | | | Example 38 of | | |
| | | | | Ink | | |
| | | | Y | Preparation | C | C |
| | | | | Example 39 of | | |
| | | | | Ink | | |
| | | | K | Preparation | C | C |
| | | | | Example 40 of | | |
| | | | | Ink | | |

1. Discharging Stability Evaluation:

According to Examples 25 to 32, it is found that when a drive pulse having an inflation waveform element (rising down voltage changing portion) having a time (voltage changing time, elapsed time) longer than 1/3 of the acoustic resonance period of the pressurized liquid chamber in the head is used, good discharging stability is obtained even for ink having low static surface tension.

2. Discharging Stability Evaluation:

By the comparison between Examples 25 to 32 and Comparative Examples 43 to 46, it is found that ink having a low static surface tension and a small receding contact angle comes to have good discharging stability when a drive pulse (discharging pulse) having an inflation waveform element (rising down voltage changing portion) having a time (voltage changing time, elapsed time) longer than 1/3 of the acoustic resonance period of the pressurized liquid chamber in the head is used.

3. Evaluation on Uniformity of Solid Portion:

By the comparison between Examples 25 to 28 and Comparative Examples 37 to 39, it is found that unless the value of the static surface tension satisfies the condition, uniformity in the solid portion is inferior. This is because if the value of the static surface tension satisfies the condition, ink permeates into a sheet soon due to the low static surface tension after the ink has landed on the sheet, thereby preventing beading to occur. If the value of static surface tension is too low, the discharging stability is worsened, which has an adverse impact on uniformity in solid portion.

4. Evaluation on Bleed Between Black in and Color Ink:

When Examples 25 to 28 are compared with Comparative Examples 37 to 39, it is found that unless the condition of the difference in the static surface tension: (the value obtained by subtracting the static surface tension of any color ink from the static surface tension of the black ink is in the range of from 0 to 4 mN/m) is met, bleed occurs. This is because when ink permeates into a sheet, the static surface tension of black ink and color ink is not well-balanced, so that texts in black become thin or bled.

Other embodiments of the present disclosure are described below.

### Embodiment A

One embodiment (Embodiment A) of the present disclosure is an inkjet recording method discharging ink droplets by a pressure generated by the pressure generating device 121 and executed by an inkjet recording device including a recording head including a nozzle plate 103 having a nozzle to discharge droplets of ink, the liquid chamber 106 communicating with the nozzle, and a pressure generating device to generate a pressure in the liquid chamber 106 and a signal generating device (the drive waveform generating unit 701 and the head driver 509) to generate a signal (a drive waveform including one or more drive pulses (discharging pulses)) applied to the pressure generating device 121. In addition, the following two conditions are satisfied:

1. The ink has a static surface tension of from 18.0 to 27.0 mN/m at 25 degrees C.
Condition 1

2. The signal has at least one drawing-in pulse in a single print cycle and the cycle of the drawing-in pulse is one third or more of a resonance period of the liquid chamber.
Condition 2

### Embodiment B

One embodiment (Embodiment B) of the present disclosure is that, in Embodiment A, the signal supplies a drive signal including a single or multiple pulses in a single print cycle to discharge one or more droplets of ink from a nozzle and has a draw-in pulse having a cycle of 1/3 or more of the resonance period of the liquid chamber 106 before the discharging pulse forming the first droplet.

### Embodiment C

One embodiment (Embodiment C) of the present disclosure is that an inkjet recording device discharging ink droplets by a pressure generated by the pressure generating device 121 in response to a signal includes a recording head including a nozzle plate 103 having a nozzle to discharge droplets of ink, the liquid chamber 106 communicating with the nozzle, and the pressure generating device 121 to generate the pressure in the liquid chamber 106 and a signal generating device (the drive waveform generating unit 701 and the head driver 509) to generate the signal (a drive waveform including one or more drive pulses (discharging pulses)) applied to the pressure generating device 121. In addition, the following two conditions are satisfied:

1. The ink has a static surface tension of from 18.0 to 27.0 mN/m at 25 degrees C.
Condition 1

2. The signal has at least one drawing-in pulse in a single print cycle and the cycle of the drawing-in pulse is one third or more of a resonance period of the liquid chamber.
Condition 2

### Embodiment D

One embodiment (Embodiment D) of the present disclosure is that, in Embodiment C, the signal supplies a drive signal including a single or multiple pulses in a single print cycle to discharge one or more droplets of ink from a nozzle and has a draw-in pulse having a cycle of 1/3 or more of the resonance period of the liquid chamber 106 before the discharging pulse forming the first droplet.

According to the present disclosure, an inkjet recording method is provided which is capable of stably discharging ink having a low static surface tension and obtaining images with high quality.

Having now fully described embodiments of the present invention, it will be apparent to one of ordinary skill in the art that many changes and modifications can be made thereto without departing from the spirit and scope of embodiments of the invention as set forth herein.

What is claimed is:

1. An inkjet recording method comprising:
supplying ink to a recording head; and
applying at least one drive pulse to a pressure generating device in the recording head to generate a pressure in a liquid chamber in the recording head to discharge one or more droplets of the ink in the liquid chamber through a nozzle of a nozzle plate in the recording head,
wherein the following two conditions are satisfied:
the ink has a static surface tension of from 18.0 to 27.0 mN/m at 25 degrees C.
Condition 1
the at least one drive pulse has a voltage changing portion drawing in the ink having a voltage changing time of one third or more of a resonance period of the liquid chamber
Condition 2.

2. The inkjet recording method according to claim 1,
wherein the ink is an ink set including black ink and at least one color ink, wherein (each ink of the ink set has a static surface tension of from 18.0 to 27.0 mN/m at 25 degrees C. and a value obtained by subtracting the static surface tension of any of the at least one color ink from the static surface tension of the black ink is from 0 to 4 mN/m.

3. The inkjet recording method according to claim 1,
wherein the at least one drive pulse is applied to the pressure generating device in a single print cycle to discharge the one or more droplets of the ink, and
wherein the at least one drive pulse forming a first droplet in the single print cycle has the voltage changing portion drawing in the ink having a voltage changing time of one third or more of the resonance period of the liquid chamber.

4. The inkjet recording method according to claim 1, wherein the nozzle plate has a repellent film on a surface from which the ink is discharged.

5. The inkjet recording method according to claim 1, wherein the ink includes water, a colorant, a surfactant, and a water-soluble organic solvent.

6. The inkjet recording method according to claim 1, wherein the ink has a viscosity of from 3 to 20 mPa·s at 25 degrees C.

7. An inkjet recording device comprising:
a recording head including a nozzle plate having a nozzle configured to discharge one or more droplets of ink,
a liquid chamber communicating with the nozzle, and a pressure generating device configured to generate a pressure in the liquid chamber; and
a drive waveform generating unit configured to generate a drive waveform including at least one drive pulse applied to the pressure generating device,
wherein the following two conditions are satisfied:
the ink has a static surface tension of from 18.0 to 27.0 mN/m at 25 degrees C.
Condition 1
the at least one drive pulse has a voltage changing portion drawing in the ink having a voltage changing time of one third or more of a resonance period of the liquid chamber
Condition 2.

8. The inkjet recording device according to claim 7,
wherein the ink is an ink set including black ink and at least one color ink,
wherein (each ink of the ink set has a static surface tension of from 18.0 to 27.0 mN/m at 25 degrees C. and) a value obtained by subtracting the static surface tension of any of the at least one color ink from the static surface tension of the black ink is from 0 to 4 mN/m.

9. The inkjet recording device according to claim 7,
wherein the at least one drive pulse is applied to the pressure generating device in a single print cycle to discharge the one or more droplets of ink,
wherein the at least one drive pulse forming a first droplet in the single print cycle has voltage changing portion drawing in the ink having a voltage changing time of one third or more of the resonance period of the liquid chamber.

10. The inkjet recording device according to claim 7, wherein the nozzle plate has a repellent film on a surface from which the ink is discharged.

11. The inkjet recording device according to claim 7, wherein the ink includes water, a colorant, a surfactant, and a water-soluble organic solvent.

12. The inkjet recording device according to claim 7, wherein the ink has a viscosity of from 3 to 20 mPa·s at 25 degrees C.
